(19) United States
(12) Patent Application Publication
(10) Pub. No.: US 2015/0140433 A1
(43) Pub. Date: May 21, 2015

(54) BATTERY ACTIVE MATERIAL, NONAQUEOUS ELECTROLYTE BATTERY AND BATTERY PACK

(71) Applicant: Kabushiki Kaisha Toshiba, Minato-ku (JP)

(72) Inventors: Kazuhiro YASUDA, Yokohama (JP); Takuya IWASAKI, Uenohara (JP); Mitsuru ISHIBASHI, Yokohama (JP); Yorikazu YOSHIDA, Yokohama (JP); Keigo HOSHINA, Yokohama (JP)

(73) Assignee: Kabushiki Kaisha Toshiba, Minato-ku (JP)

(21) Appl. No.: 14/547,534

(22) Filed: Nov. 19, 2014

(30) Foreign Application Priority Data
Nov. 20, 2013 (JP) 2013-240090

(51) Int. Cl. H01M 4/36; H01M 4/587; H01M 4/485; H01M 4/131; H01M 4/133

(52) U.S. Cl. CPC H01M 4/366; H01M 4/131; H01M 4/133; H01M 4/485; H01M 4/587; H01M 2004/027
USPC 429/231.1

(57) ABSTRACT

A battery active material of the present embodiment includes a first active material and a second active material. The first active material contains a neutral or acidic active material substrate formed of a titanium oxide or a titanate compound, and an inorganic compound layer covering a surface of the active material substrate. The second active material is basic and is formed of a titanium oxide or a titanate compound. The first active material and/or the second active material are covered with a carbon coating layer.

### CROSS-REFERENCE TO RELATED APPLICATION

This application is based upon and claims the benefit of priority from Japanese Patent Application No. 2013-240090, filed Nov. 20, 2013, the entire contents of which are incorporated herein by reference.

### FIELD

Embodiments described herein relate generally to a battery active material, a nonaqueous electrolyte battery and a battery pack.

### BACKGROUND

In a nonaqueous electrolyte battery obtained by using a titanate compound in a negative electrode, lithium dendrite is less likely to occur than in a nonaqueous electrolyte battery obtained by using a carbonaceous material because a titanate compound has the higher Li absorption-release potential than a carbonaceous material. Also, because a titanate compound is ceramics, thermal runaway is less likely to occur. Therefore, a nonaqueous electrolyte battery obtained by using a titanate compound is regarded as a highly safe product.

However, a titanate compound has the higher reactivity to a nonaqueous electrolyte than a generally used graphite type negative electrode. The reaction of a titanate compound with a nonaqueous electrolyte can cause the problems such as the increase in impedance due to the decomposed materials of a nonaqueous electrolyte generated on the surface of a titanate compound, and the bulge of a battery due to the generation of a gas. Therefore, a nonaqueous electrolyte battery obtained by using a titanate compound may have a short cycle lifespan. In particular, in a nonaqueous electrolyte battery obtained by using a titanate compound with the crystal structure of the monoclinic titanium dioxide, there is the problem of an extremely short cycle lifespan.

### BRIEF DESCRIPTION OF DRAWINGS

FIG. 1 is a schematic diagram for explaining a battery active material of a first embodiment.

FIG. 2 is a schematic diagram for explaining a battery active material of a second embodiment.

FIG. 3 is a sectional view illustrating an example of a flat type nonaqueous electrolyte battery according to a second embodiment.

FIG. 4 is an enlarged sectional view illustrating a part A shown in FIG. 3.

FIG. 5 is a partial cutout perspective view schematically illustrating another example of the flat type nonaqueous electrolyte battery according to the third embodiment.

FIG. 6 is an enlarged schematic sectional view illustrating a part B of FIG. 5.

FIG. 7 is an exploded perspective view illustrating a battery pack according to a fourth embodiment.

FIG. 8 is a block diagram illustrating an electric circuit included in the battery pack shown in FIG. 7.

### DESCRIPTION OF EMBODIMENTS

A battery active material according to an embodiment includes: a first active material containing a neutral or acidic active material substrate formed of a titanium oxide or a titanate compound, and an inorganic compound layer covering a surface of the active material substrate; and a basic second active material formed of a titanium oxide or a titanate compound. The surfaces of the first active material and/or the second active material are covered with a carbon coating layer.

Hereinafter, the embodiments will be described with reference to the drawings. The same reference signs are put to the common features in the embodiments, and duplicative descriptions are omitted. Also, the respective drawings are the schematic diagrams for supporting the description of the embodiments. The shape, size and ratio illustrated in the drawings may be different from actual devices, but design changes can be appropriately carried out with reference to the following description and publicly known techniques.

### First Embodiment

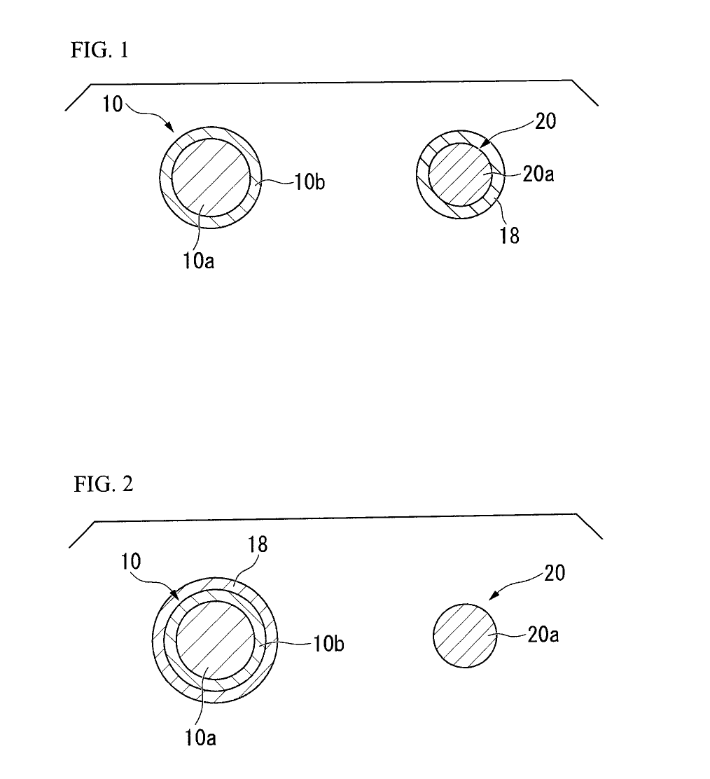

FIG. 1 is a schematic diagram for explaining a battery active material of the first embodiment. The battery active material shown in FIG. 1 includes the first active material 10 and the second active material 20. The first active material 10 contains an active material substrate 10a and an inorganic compound layer 10b covering the surface of the active material substrate 10a. The first active material 10 is formed of a titanium oxide or a titanate compound, and is neutral or acidic. The second active material 20 is formed of a titanium oxide or a titanate compound 20a, and is basic. As shown in FIG. 1, the surface of the second active material 20 is covered with the carbon coating layer 18 composed of carbon.

The first active material 10 and the second active material 20 respectively have the different characteristics. In the battery active material of the present embodiment, excellent battery characteristics can be obtained according to an application by combining the first active material 10 and the second active material 20 in an arbitrary ratio.

For example, when the first active material 10 contains the active material substrate 10a with the TiO₂ (B) structure, a voltage decreases with the passage of a discharging time in the nonaqueous electrolyte battery obtained by using the first active material 10 alone as a battery active material of a negative electrode (anode) and using a lithium iron phosphate as an active material of a positive electrode (cathode). This is because the first active material 10 which contains the active material substrate 10a with the TiO₂ (B) structure has an electrical potential which continuously changes by coming and going of Li ions at the time of charging and discharging. In the nonaqueous electrolyte battery whose voltage decreases with the passage of a discharging time, it is possible to know a remaining capacity by detecting a voltage.

By contrast, for example, when the second active material 20 is formed of Li₄Ti₅O₁₂, the change of a voltage is very small with the passage of a discharging time in the nonaqueous electrolyte battery obtained by using the second active material 20 alone as a battery active material of a negative electrode and using a lithium iron phosphate as an active material of a positive electrode. This is because both of a lithium iron phosphate and Li₄Ti₅O₁₂ have the broad range in which an electrical potential shows a constant even by coming and going of Li ions at the time of charging and discharging (the discharging time when a voltage shows a constant is long). Therefore, in the nonaqueous electrolyte battery obtained by using Li₄Ti₅O₁₂ as a battery active material of a negative electrode and using a lithium iron phosphate as an active material of a positive electrode, it is difficult to know a remaining capacity of a battery by detecting a voltage of a battery.

When the battery active material of the present embodiment includes the first active material 10 containing the active material substrate 10a with the TiO₂ (B) structure and the second active material 20 formed of Li₄Ti₅O₁₂, it is possible to improve the cycle characteristics as compared with when the first active material 10 is used alone. In addition, the decrease in a voltage is very small with the passage of a discharging time. However, it has been difficult to combine the first active material 10 and the second active material 20 for the following reasons.

In the first active material 10, the inorganic compound layer 10b covering the active material substrate 10a is provided in order to suppress the reactivity of the active material substrate 10a to a nonaqueous electrolyte. The inorganic compound layer 10b is sensitive to basicity. Therefore, when the battery active material includes the first active material 10 obtained by covering the surface of the active material substrate 10a with the inorganic compound layer 10b, and a basic active material, the inorganic compound layer 10b cannot maintain a stable coated form. As a result, the effect of the inorganic compound layer 10b, which suppresses the reactivity of the active material substrate 10a to a nonaqueous electrolyte, becomes insufficient, and there was the problem that the deterioration of cycle characteristics, etc. occurs.

This problem significantly appears when the ratio of a basic active material to the first active material 10 in the battery active material is large or when the ratio of the conductive material constituting electrodes is small and the first active material 10 and a basic active material are likely to contact each other.

By contrast, the battery active material of the present embodiment shown in FIG. 1 includes the first active material 10 obtained by covering the surface of the active material substrate 10a with the inorganic compound layer 10b and the basic second active material 20. Also, the surface of the second active material 20 is covered with the carbon coating layer 18 composed of carbon. Thus, the contact between the inorganic compound layer 10b covering the surface of the first active material 10 and the basic second active material 20 in the battery active material is prevented by the carbon coating layer 18. For this reason, the inorganic compound layer 10b can stably exist in the battery active material, and it is possible to suppress the reactivity of the active material substrate 10a to a nonaqueous electrolyte.

In the battery active material of the present embodiment, the contact between the inorganic compound layer 10b covering the surface of the first active material 10 and the basic second active material 20 is prevented by the carbon coating layer 18. Therefore, the ratio of the first active material 10 and the second active material 20 is set to the range by which the effect due to the combination thereof can be obtained, and for example, it is preferable that the mass ratio (the first active material:the second active material) be within the range of 30:70 to 90:10.

Also, the carbon coating layer 18 coating the surface of the second active material 20 has good conductivity. Thereby, it is possible to suppress the decrease in the function as a battery active material of the second active material 20 even when the surface of the second active material 20 is coated with the carbon coating layer 18.

Also, the active material substrate 10a with the TiO₂ (B) structure has the particularly high reactivity to a nonaqueous electrolyte. Thus, when the active material substrate 10a has the TiO₂ (B) structure, by using the carbon coating layer 18 to prevent the contact between the inorganic compound layer 10b and the basic second active material 20, it is easy to obtain the effect of the inorganic compound layer 10b for suppressing the reactivity of the active material substrate 10a to a nonaqueous electrolyte.

The mass (coating amount) of the carbon coating layer 18 is preferably within the range of 0.1 to 3 mass % ((carbon coating layer/second active material)×100) of the mass of the second active material 20, and more preferably the range of 0.5 to 2.5 mass %. When the coating amount is 0.1 mass % or more, it is possible to sufficiently suppress the adverse effect of the basic second active material 20 to the inorganic compound layer 10b. When the coating amount is 3 mass % or less, the carbon coating layer 18 rarely suppresses that Li, which exists on the surface of the second active material 20, diffuses into the active material, which is preferred. Also, when the coating amount is 3 mass % or less, because a specific surface area is increased by providing the carbon coating layer 18, the improvement in electrode density is not suppressed in a rolling process after the production of an electrode, which is preferred.

The thickness of the carbon coating layer 18 is preferably within the range of 10 to 1000 nm. When the thickness of the carbon coating layer 18 is within the aforementioned range, it is possible to sufficiently suppress the adverse effect to the inorganic compound layer 10b which occurs by the contact between the basic second active material 20 and the inorganic compound layer 10b. In order to more efficiently suppress the adverse effect of the basic second active material 20 to the inorganic compound layer 10b, the thickness of the carbon coating layer 18 is more preferably set to 100 nm or more. Also, when the thickness of the carbon coating layer 18 is within the aforementioned range, it is possible to suppress that the function as a battery active material of the second active material 20 is deteriorated by the coating with the carbon coating layer 18. In order to further suppress the decrease in the function as a battery active material of the second active material 20, the thickness of the carbon coating layer 18 is more preferably set to 1000 nm or less. When the carbon coating layer 18 is too thick, the decrease in energy density occurs with the increase in carbon weight in the nonaqueous electrolyte battery obtained by using the battery active material of the present embodiment. Also, the binding property of the battery active material and a conductive agent decreases with the increase in a specific surface area, and an extra amount of binder is required to compensate for this. Also, the decrease in electrode density is caused, and the decrease in energy density occurs.

The thickness of the carbon coating layer 18 formed on the surface of the second active material 20 is measured by cross-sectional observation of an active material as described below. The second active material to be subjected to cross-sectional observation may be obtained in the state of the second active material or the state of an electrode. When the second active material to be subjected to cross-sectional observation is obtained in the state of the second active material, the thickness of the carbon coating layer 18 is measured by the cross-sectional observation thereof. When the second active material to be subjected to cross-sectional observation is obtained in the state of an electrode, the battery active material is obtained by an extraction method for an electrode. Then, the thickness of the carbon coating layer formed on the surface of the second active material is measured by the cross-sectional observation of the battery active material.

In the method for extract a battery active material from an electrode, an electrode is immersed in pure water or a nonaqueous solvent such as NMP (N-methylpyrrolidone) so as to extract a battery active material and a conductive agent (such as a carbon type material), and a battery active material and a conductive agent are separated from a current collector (current collector foil). Then, the liquid in which a battery active material and a conductive agent are dispersed is diluted, and added into a beaker, and then a battery active material and a carbon type material, i.e. a conductive agent, are obtained by using a general ultrasonic washing machine (usually 15 to 400 kHz).

In the specific example, a negative electrode 1 g formed on the both faces of a current collector (current collector foil) is immersed in a solvent 500 mL such as water or NMP so as to extract a battery active material and a conductive agent in a solvent and to separate them from a current collector. Then, the solution in which a battery active material and a conductive agent are dispersed is diluted about 20 times so as to prepare a diluted solution. The obtained diluted solution 100 mL is added into a beaker and subjected to the process using the ultrasonic washing machine (SW5800) manufactured by Citizen Systems Japan Co. Ltd. for about 20 minutes. Thereafter, about 0.3 mL of the diluted solution is sampled and subjected to a drying process so as to obtain the mixed powder of a battery active material and a conductive agent

An electrode contains the first active material and the second active material, but the respective materials exist in a dispersed state in the mixed powder obtained by the extraction from an electrode and drying. For this reason, it is easy to distinguish these materials when the configuration of the mixed powder is observed by SEM (Scanning Electron Microscope) or TEM (Transmission Electron Microscope).

By subjecting the mixed powder of the active material derived from an electrode and a conductive agent, or the single active material to cross-sectional SEM observation or cross-sectional TEM observation, it is possible to detect the carbon existing on the second active material. Generally, the carbon material used for a conductive agent is a shaped or shapeless material, and is in the state of being separated from the battery active material through the aforementioned process. For this reason, it is possible to distinguish the carbon material used for a conductive agent and the carbon coating layer which was intentionally coated on the surface of the second active material.

The thickness of the carbon coating layer coated on the surface of the second active material can be measured by the method described below. Firstly, the cross-section of the second active material 20 having the surface coated with the carbon coating layer is observed by SEM or TEM. Then, 5 to 10 particles are selected from among the particles whose cross-sections corresponding to average particle sizes have been observed by SEM or TEM, and are subjected to the measurement of the distance from the interface between the active material and the carbon coating to the outer surface of the carbon coating layer. Then, the average value of the measurement results is defined as the thickness of the carbon coating layer formed on the surface of the second active material.

### [First Active Material]

The active material substrate 10a of the first active material 10 is formed of a titanium oxide or a titanate compound, and is neutral or acidic. The active material substrate 10a preferably has acid sites in solid acid and a hydroxide group on the surface thereof. Specific examples of the active material substrate 10a include the compounds of TiO₂ (rutile), the monoclinic titanium dioxide (TiO₂ (B)), TiO₂—P₂O₅ (such as TiP₂O₇), TiO₂—V₂O₅, TiO₂—Nb₂O₅, MgTi₂O₅, TiNb₂O₇, TiO₂—SnO₂, and TiO₂—P₂O₅-MeO (Me=Cu, Ni, Fe and Co).

The active material substrate 10a preferably has the crystal structure of the monoclinic titanium dioxide (TiO₂ (B)). This type of the active material substrate 10a has a high theoretical capacity. For this reason, the increase in a capacity can be expected in the nonaqueous electrolyte battery obtained by using the active material substrate 10a having the crystal structure of the monoclinic titanium dioxide (TiO₂ (B)).

The crystal structure of the monoclinic titanium dioxide mainly belongs to the space group C2/m, and shows a tunnel structure. In the present specification, the crystal structure of the monoclinic titanium dioxide is referred to as the TiO₂ (B) structure.

The active material substrate 10a with TiO₂ (B) structure can be represented by the general formula LiₓTiO₂ (0≦x≦1). X in this formula varies between 0 and 1 by the charging and discharging reaction.

By measuring the powder X-ray diffraction using Cu—Kα ray as a radiation source, it can be confirmed that the crystal structure of the active material substrate 10a has the TiO₂ (B) structure.

### (Powder X-Ray Diffraction)

The measurement of the crystal structure of TiO₂ (B) using the powder X-ray diffraction can be carried out as follows.

Firstly, a sample subjected to measurement, i.e. the first active material 10, is pulverized such that the average particle size becomes about 5 μm. The average particle size can be measured by laser diffractometry. Next, the pulverized sample is charged into the holder portion with depth of 0.2 mm formed on a glass sample plate. At this time, it should be noted that the sample is sufficiently charged in the holder portion. Also, the attention should be paid so as not to cause cracks and voids, etc. due to the lack of the charged amount of the sample. Then, the sample is sufficiently pressed from the outside using another glass plate so as to smooth the surface thereof The attention should be paid so as not to cause a concavo-convex shape at the base level of the holder. Then, the glass sample plate filled with the sample is placed in a powder X-ray diffractometer, and the diffraction pattern is obtained using Cu—Kα ray.

In the diffraction spectrum of the crystal structure of TiO₂ (B) obtained by a powder X-ray diffraction method, the crystal structure of the active material substrate 10a can be measured without being affected by the inorganic compound layer 10b when the content of the inorganic compound layer 10b covering the surface of the active material substrate 10a of the first active material 10 is within the range of 1 to 20 mass % of the mass of the active material substrate 10a (TiO₂ conversion).

The active material substrate 10a with the TiO₂ (B) structure can contain a hetero element. As a hetero element, it is possible to use at least one element selected from Zr, Nb, Mo, Ta, Y, P and B. Of these elements, Nb is preferred. By using the active material substrate 10a with the TiO₂ (B) structure containing Nb, it is possible to obtain a nonaqueous electrolyte battery having a higher capacity. When the hetero element is contained in the active material substrate 10a with the TiO₂ (B) structure, the influence of the Lewis acid sites on the surface of the active material substrate 10a is suppressed. As a result, the increase in resistance of the first active material 10 is suppressed, and the cycle lifespan is improved.

The hetero element is preferably contained at the range of 0.01 to 8 mass % relative to the total weight of the active material substrate 10a with the TiO₂ (B) structure ((the hetero element/the active material substrate with the TiO₂ (B) structure containing the hetero element)×100). When the hetero element is contained at 0.01 mass % or more, the influence of Lewis acid sites on the surface of the active material substrate 10a can be declined. The hetero element is preferably contained at 8 mass % or less in terms of the solid-solution limit of the hetero element. The hetero element is more preferably contained at the range of 0.05 to 3 mass % relative to the total weight of the active material substrate 10a.

The content of the hetero element contained in the active material substrate 10a with the TiO₂ (B) structure can be measured by inductively coupled plasma (ICP) emission spectroscopy.

The specific surface area of the active material substrate 10a is preferably 5 m²/g or more and 100 m²/g or less. When the specific surface area of the active material substrate 10a is 5 m²/g or more, it is possible to sufficiently prepare the absorption-release sites for the lithium ions. As a result, it is possible to increase the capacity of a nonaqueous electrolyte battery. When the specific surface area of the active material substrate 10a is 100 m²/g or less, it is possible to improve the coulombic efficiency during charging and discharging.

The active material substrate 10a is neutral or acidic, and has acid sites in solid acid and a hydroxide group on the surface thereof, and thus, has high reactivity to a nonaqueous electrolyte. For this reason, in the non-aqueous electrolyte battery in which the surface of the active material substrate 10a is not coated with the inorganic compound layer 10b and only the active material substrate 10a is used as a negative electrode active material, the excess inorganic film and organic film are formed on the surface of the active material substrate 10a in connection with the charging and discharging. As a result, the decrease in electrode performance, the increase in internal resistance of a nonaqueous electrolyte battery, and the deterioration of a nonaqueous electrolyte occur, which causes the reduction in the cycle lifespan of a nonaqueous electrolyte battery.

In particular, the active material substrate 10a with the TiO₂ (B) structure is a solid acid, and thus has the high reactivity to a nonaqueous electrolyte. Therefore, there is the problem that the reduction in the cycle lifespan is remarkably caused for the aforementioned reasons.

By the way, in the nonaqueous electrolyte battery obtained by using a carbonaceous material or a lithium titanate with a spinel structure as a negative electrode active material, by adding a vinylene carbonate to the nonaqueous electrolyte, it is possible to suppress the reaction between a negative electrode and the nonaqueous electrolyte. In this type of nonaqueous electrolyte battery, a vinylene carbonate is reduced and decomposed on a negative electrode, to thereby form a stable coating film on a negative electrode. For this reason, a negative electrode and the nonaqueous electrolyte are less likely to react with each other, and it is suppressed that an excess coating film is formed on a negative electrode.

However, the active material substrate 10a is neutral or acidic, and has acid sites in solid acid and/or a hydroxide group, etc. on the surface thereof. For this reason, in the nonaqueous electrolyte battery using the active material substrate 10a as a negative electrode active material, the reaction between a negative electrode and a nonaqueous electrolyte is not suppressed even when a vinylene carbonate is added. Therefore, there is the problem that in connection with the charging and discharging, a coating film is formed on the surface of the active material substrate 10a, the resistance of a negative electrode is increased, and cycle lifespan is reduced.

In order to solve this problem, in the first active material 10 shown in FIG. 1, the surface of the active material substrate 10a is coated with the inorganic compound layer 10b. In this case, because Lewis acid sites on the surface of the active material substrate 10a are covered with the inorganic compound layer 10b, the influence of Lewis acid sites is declined. As a result, it can be considered that the reactivity of the active material substrate 10a to the nonaqueous electrolyte is suppressed. Therefore, by using the first active material 10 obtained by coating the surface of the active material substrate 10a with the inorganic compound layer 10b, it is possible to suppress the increase in resistance of a nonaqueous electrolyte battery and to cycle lifespan thereof as compared with the case of using the active material substrate 10a whose surface is not coated with the inorganic compound layer 10b.

It can be confirmed by observation of the first active material 10 using SEM or TEM that the surface of the active material substrate 10a is coated with the inorganic compound layer 10b.

The first active material 10 shown in FIG. 1 is obtained by coating the surface of the active material substrate 10a with the inorganic compound layer 10b, and thus has a peak within the region of 1580 cm⁻¹ to 1610 cm⁻¹ in the infrared diffuse reflectance spectrum after the adsorption and desorption of pyridine, and also, the peak attributed to Lewis acid sites is decreased as compared to the active material substrate 10a.

In more details, the first active material 10 shown in FIG. 1 has the lower influence of Lewis acid sites than the active material substrate 10a. Therefore, when the first active material 10 obtained by coating the surface of the active material substrate 10a with the inorganic compound layer 10b is measured by infrared diffuse reflectance spectroscopy, it can be confirmed that the peak attributed to Lewis acid sites of the active material substrate 10a is decreased as compared to the active material substrate 10a which was not coated with the inorganic compound layer 10b.

Specifically, the first active material 10 has the lower intensity of the peak, which is attributed to Lewis acid sites and exists within the region of 1430 cm⁻¹ to 1460 cm⁻¹ in the infrared diffuse reflectance spectrum, than t the active material substrate 10a.

Also, in the infrared diffuse reflectance spectroscopy, it is possible to distinguish Lewis acid sites for receiving protons and Bronsted acid sites for donating protons by the measurement after pyridine has been adsorbed and desorbed to the first active material 10. In addition, in the infrared diffuse reflectance spectroscopy, it is possible to measure the peak attributed to the hydrogen bonding between the first active material 10 and pyridine.

Specifically, the first active material 10 shows the peak attributed to the hydrogen bonding within the region of 1430 cm⁻¹ to 1460 cm⁻¹. This peak is not detected in the case of measuring the infrared diffuse reflectance spectrum of the active material substrate 10a. As a result, the intensity of the peak appearing within the region of 1430 cm⁻¹ to 1460 cm⁻¹ is increased in the first active material 10 as compared with the infrared diffuse reflectance spectrum of the active material substrate 10a alone. Also, the first active material 10 shows the peak attributed to the hydrogen bonding within the region of 1580 cm⁻¹ to 1610 cm⁻¹ in the infrared diffuse reflectance spectrum. This peak is not detected in the active material substrate 10a, and can be obtained by the existence of the inorganic compound layer 10b.

### (Infrared Diffuse Reflectance Spectroscopy)

Firstly, a battery active material to be measured is added in the sample cup, and this sample cup is placed in an infrared diffuse reflectance measurement device. Next, while distributing a nitrogen gas into a cell of the device at 50 mL/min, a battery active material is heated to 500° C., and held for 1 hour. Then, the temperature of a battery active material is decreased to room temperature, and is increased to 100° C., again. Subsequently, the cell in which the sample cup has been placed is depressurized, and the vapor of pyridine is introduced in the cell such that pyridine is adsorbed by a battery active material for 30 minutes. Subsequently, while distributing a nitrogen gas into the cell of the device at 100 mL/min, a battery active material is held at 100° C. for 1 hour. Then, the temperature of a battery active material is increased to 150° C., and held for 1 hour, to thereby desorb the physically adsorbing or hydrogen-bonded pyridine from a battery active material. Then, the infrared diffuse reflectance measurement of a battery active material is carried out.

In the obtained infrared diffuse reflectance spectrum, the background is eliminated, and the peak area is calculated.

According to this infrared diffuse reflectance spectroscopy, because the functional groups present in the sample can be found, it is possible to clarify the configuration of a measurement sample.

When measuring a battery active material contained in an electrode, a battery active material is extracted from an electrode and subjected to measurement. For example, a battery active material-containing layer is peeled off from a current collector of an electrode, and polymer materials and a conductive agent, etc. are removed, to thereby extract a battery active material from an electrode.

Specifically, a Soxhlet extraction method can be used to remove polymer materials from a battery active material-containing layer, which has been peeled off from a current collector of an electrode, to thereby extract carbon materials, which are a battery active material and a conductive agent. By using N-methylpyrrolidone (NMP) as a solvent in a Soxhlet extraction method, it is possible to efficiently remove polymer materials from a battery active material-containing layer. Then, the polymer materials are oxidized by using oxygen or ozone and removed as carbon dioxide from the mixture of a battery active material and carbon materials which has been obtained by a Soxhlet extraction method. By using this process, only a battery active material can be extracted from an electrode.

It is preferable that the inorganic compound layer 10b covering the surface of the active material substrate 10a include a metal oxide or a composite oxide which contains Al or Si.

Also, it is preferable that the inorganic compound layer 10b cover the entire surface of the active material substrate 10a.

The total mass of the inorganic compound layer 10b is preferably within the range of 1 to 20 mass % ((the inorganic compound layer/the active material substrate)×100) of the mass of the active material substrate 10a (TiO₂ conversion). When the inorganic compound layer 10b exists at 1 mass % or more of the mass of the active material substrate 10a, it is possible to effectively suppress the reaction between the active material substrate 10a and a nonaqueous electrolyte. Also, when the mass of the inorganic compound layer 10b is set to 20 mass % or less of the mass of the active material substrate 10a, it is possible to suppress the decrease in a battery capacity due to the formation of the inorganic compound layer 10b.

The desired content of the inorganic compound layer 10b varies depending on the addition amounts of a conductive agent and a binder in an electrode. In an electrode wherein the addition amounts of a conductive agent and/or a binder are large, it is possible to reduce the content of the inorganic compound layer 10b with respect to the mass of the active material substrate 10a. Although depending on the types of a conductive agent and a binder to be used, for example, when the total weight of a conductive agent and a binder is 10 parts by weight or more with respect to 100 parts by weight of the active material substrate 10a, the inorganic compound layer 10b is contained preferably at 1 to 10 mass % by mass of the mass of the active material substrate 10a, and more preferably at 1 to 8 mass %. Meanwhile, when the total weight of a conductive agent and a binder is less than 10 parts by weight with respect to 100 parts by weight of the active material substrate 10a, the content of the inorganic compound layer 10b is preferably at 5 to 15 mass % relative to the mass of the active material substrate 10a, and more preferably at 5 to 12 mass %.

The total mass of the inorganic compound layer 10b with respect to the mass of the active material substrate 10a can be calculated by the following method which combines wet analysis using inductively coupled plasma (ICP) emission spectroscopy and elemental analysis using SEM (scanning electron microscope)—EDX (energy dispersive X-ray spectroscopy).

When measuring a battery active material contained in an electrode within a nonaqueous electrolyte battery, a battery active material is extracted in the same manner as the aforementioned case of measuring a battery active material using infrared diffuse reflectance spectroscopy. Then, the obtained battery active material is eluted in an acid solvent, and is subjected to ICP emission spectroscopy to measure the total composition of the constituent components of the first active material 10.

Next, the sample, which is obtained by embedding the battery active material in an epoxy resin, etc. and cutting this, is observed using SEM-EDX. Through this observation, the inorganic compound layer 10b covering the surface of the active material substrate 10a is observed and elemental analysis of the active material substrate 10a, and the inorganic compound layer 10b is carried out using EDX equipped with the SEM.

Thereafter, the results of the total composition amount of the first active material 10 measured by ICP emission spectroscopy are combined with the results of elemental analysis using SEM-EDX so as to calculate the masses of the respective components of the active material substrate 10a and the inorganic compound layer 10b. Then, the total mass of the inorganic compound layer 10b with respect to the mass of the active material substrate 10a is calculated based on the masses of the respective components of the active material substrate 10a and the inorganic compound layer 10b.

### [Production Method of First Active Material]

The titanium oxide or titanate compound contained in the active material substrate 10a of the first active material 10 may be obtained by synthesis from raw materials or by purchasing commercially available one.

As an example of the synthesis of the titanium oxide or titanate compound used in the active material substrate 10a, the following descriptions explain the synthesis method of the titanium oxide with the TiO₂ (B) structure which contains no hetero element and the synthesis method of the titanium oxide with the TiO₂ (B) structure which contains the hetero element.

(Synthesis Method of Titanium Oxide with TiO₂ (B) Structure which Contains No Hetero Element)

The synthesis method of the titanium oxide with the TiO₂ (B) structure which contains no hetero element includes: a step in which a Ti-containing compound and an alkali element-containing compound are mixed and heated to thereby synthesize an alkali titanate compound; a step in which the alkali titanate compound and an acid are reacted such that alkali cations are exchanged for protons, to thereby obtain the proton titanate compound; and a step in which the proton titanate compound is heated one or more times.

Firstly, a Ti-containing compound and an alkali element-containing compound are used as starting materials. These starting materials are mixed at a predetermined stoichiometric ratio, and are subjected to the heating treatment so as to synthesize the alkali titanate compound. Examples of the alkali titanate compound to be synthesized include sodium titanate, potassium titanate and cesium titanate. The crystal form of the synthesized alkali titanium compound may be any shape. The heating treatment can be carried out at 800° C. to 1100° C.

As examples of the Ti-containing compound of the starting materials, it is possible to use one or more compounds selected from the anatase type TiO₂, the rutile type TiO₂ and TiCl₄.

As the alkali element-containing compound, it is possible to use a compound containing an element selected from Na, K and Cs. Specifically, it is possible to use one or more compounds selected from carbonates, hydroxides and chlorides, etc. which contain an element selected from Na, K, and Cs.

Next, the proton exchange is carried out by subjecting the alkali titanate compound to an acid treatment. Before carrying out an acid treatment, it is preferable to sufficiently wash the alkali titanate compound using distilled water so as to remove impurities. Then, the alkali titanate compound is subjected to an acid treatment such that the alkali cations of the alkali titanate compound are exchanged for protons, to thereby obtain the proton titanate compound.

In alkali compounds such as sodium titanate, potassium titanate and cesium titanate, the alkali cations can be exchanged for protons without destroying the crystal structure.

The acid treatment for the alkali titanate compound can be carried out by adding an acid to the powder of the alkali titanate compound, followed by stirring, for example. As an acid, it is possible to use an acid selected from hydrochloric acid, nitric acid and sulfuric acid. It is preferable that the concentration of an acid be within the range of 0.5 to 2 mol/L. The acid treatment is preferably continued until the alkali cations are sufficiently exchanged for protons. The time of the acid treatment is not particularly limited, but it is preferable to carry out the acid treatment at room temperature of about 25° C. for 24 hours or more, and more preferably 1 to 2 weeks. Furthermore, it is more preferable to renew an acid solution every 24 hours. Examples of the conditions for the acid treatment include room temperature, 1 mol/L of sulfuric acid, and 24 hours.

For example, by carrying out the acid treatment for the alkali titanate compound while applying vibration such as ultrasound, it is possible to more smoothly achieve the proton exchange.

Also, in order to perform the proton exchange more efficiently, it is preferable to preliminarily pulverize the alkali titanate compound using a ball mill or the like. For example, pulverization can be carried out by the method of placing zirconia balls having a diameter of approximately 10 to 15 mm in the container of 100 cm² and rotating zirconia balls at a rotation speed of 600 to 1000 rpm for 1 to 3 hours. By carrying out pulverization for 1 hour or more, it is possible to sufficiently pulverize the alkali titanate compound. By setting pulverization time to 3 hours or less, it is possible to prevent that the compounds other than the target product are produced by a mechanochemical reaction.

After the completion of the proton exchange of the alkali titanate compound in the acid treatment, an alkaline solution such as a lithium hydroxide aqueous solution is appropriately added in the solution containing an acid and the proton titanate compound, to thereby neutralize a remaining acid. After neutralization, the proton titanate compound is washed with distilled water and dried. It is preferable that the washing of the proton titanate compound is carried out sufficiently until a pH of washing water is within the range of 6 to 8. Alternatively, it is possible to proceed to the next step without carrying out the neutralization of the remaining acid, the washing and the drying after the acid treatment.

Next, the proton titanate compound is subjected to the heating treatment. The heating treatment can be carried out once or several times. In terms of removing water contained in the titanium oxide, it is preferable to carry out the heating treatment several times. The first heating treatment is preferably carried out at a temperature within the range of 350° C. to 500° C. for 1 to 3 hours. Subsequently, the obtained titanium oxide can be subjected to the second heating treatment. The second heating treatment is preferably carried out at a temperature within the range of 200° C. to 300° C. for 1 to 24 hours. By carrying out the second heating treatment, it is possible to remove the water adsorbing to the titanium oxide. Moreover, the titanium oxide subjected to the second heating treatment can be subjected to the additional heating treatment at a temperature within the range of 200° C. to 300° C.

Through the method described above, it is possible to synthesize the titanium oxide with the TiO₂ (B) structure which contains no hetero element. In the titanium oxide with the TiO₂ (B) structure obtained by the method described above, Li can be preliminarily added by using a Li-containing compound as the starting material. Also, Li can be absorbed by the Li-free titanium oxide with the TiO₂ (B) structure through charging and discharging.

(Synthesis Method of Titanium Oxide with TiO₂ (B) Structure which Contains Hetero Element)

The following description explains the synthesis method of the titanium oxide with the TiO₂ (B) structure which contains the hetero element. This synthesis method includes: a step in which a Ti-containing compound, an alkali element-containing compound and a hetero element-containing compound are mixed and heated to thereby synthesize an alkali titanate compound containing the hetero element; a step in which the alkali titanate compound containing the hetero element and an acid are reacted such that alkali cations are exchanged for protons, to thereby obtain the proton titanate compound containing the hetero element; and a step in which the proton titanate compound containing the hetero element is heated to thereby produce the titanium oxide which has the crystal structure of a monoclinic titanium dioxide and contains the hetero element.

Firstly, a Ti-containing compound, an alkali element-containing compound and a hetero element-containing compound are prepared as starting materials. Subsequently, these starting materials are mixed at a predetermined stoichiometric ratio, and are subjected to the heating treatment so as to synthesize the alkali titanate compound containing the hetero element. The crystal form of the synthesized alkali titanium compound may be any shape. The heating temperature for the synthesis of the alkali titanium compound which contains the hetero element can be set to 800-1100° C., for example.

Among the starting materials, as the Ti-containing compound and the alkali element-containing compound, it is possible to use the same compounds described in the aforementioned synthesis method of the titanium oxide with the TiO₂ (B) structure.

As the hetero element-containing compound, it is possible to use the compound containing at least one element selected from Zr, Nb, Mo, Ta, Y, P and B, and so on. Specifically, it is possible to use at least one compound selected from carbonates and hydroxides, etc. which contain at least one element selected from Zr, Nb, Mo, Ta, Y, P and B.

The alkali titanate compound containing the hetero element is not particularly limited, but examples thereof include sodium titanate, potassium titanate and cesium titanate, those containing the hetero element.

Next, the proton exchange is carried out by subjecting the alkali titanate compound containing the hetero element to the acid treatment. Before carrying out the acid treatment, it is preferable to sufficiently wash the alkali titanate compound containing the hetero element using distilled water so as to remove impurities. Then, the alkali titanate compound is subjected to the acid treatment such that the alkali cations of the alkali titanate compound are exchanged for protons, to thereby obtain the proton titanate compound containing the hetero element.

In alkali compounds such as sodium titanate, potassium titanate and cesium titanate, those containing the hetero element, the alkali cations can be exchanged for protons without destroying the crystal structure in the same manner as the case of containing no hetero element.

The acid treatment can be carried out by adding an acid to the powder of the alkali titanate compound containing the hetero element, followed by stirring, for example. As an acid, it is possible to use an acid selected from hydrochloric acid, nitric acid and sulfuric acid. It is preferable that the concentration of an acid be within the range of 0.5 to 2 mol/L. The acid treatment is preferably continued until the alkali cations are sufficiently exchanged for protons. The time of the acid treatment is not particularly limited, but it is preferable to carry out the acid treatment for 24 hours or more under the conditions of room temperature of about 25° C. and the use of a hydrochloric acid with a concentration of 1 mol/L, and more preferably about 1 to 2 weeks. Furthermore, it is more preferable to renew an acid solution every 24 hours.

In the case of the synthesis of the titanium oxide with the TiO₂ (B) structure which contains the hetero element, the acid treatment can be carried out while applying vibration such as ultrasound in the same manner as the case of the synthesis of the titanium oxide with the TiO₂ (B) structure which contains no hetero element. Also, in order to perform the proton exchange more efficiently, it is preferable to preliminarily pulverize the alkali titanate compound using a ball mill or the like.

After the completion of the proton exchange of the alkali titanate compound containing the hetero element in the acid treatment, an alkaline solution such as a lithium hydroxide aqueous solution is appropriately added in the solution containing an acid and the proton titanate compound, to thereby neutralize a remaining acid. After neutralization, the obtained proton titanate compound containing the hetero element is washed with distilled water and then dried. It is preferable that the washing of the proton titanate compound containing the hetero element is carried out sufficiently until a pH of washing water is within the range of 6 to 8. Alternatively, it is possible to proceed to the next step without carrying out the neutralization of the remaining acid, the washing and the drying after the acid treatment.

Next, by subjecting the proton titanate compound containing the hetero element to the heating treatment, it is possible to obtain the titanium oxide with the TiO₂ (B) structure which contains the hetero element.

The temperature of the heating treatment is preferably within the range of 250° C. to 500° C., and the optimal temperature can be set based on the conditions of the composition, particle size and crystal structure of the proton titanate compound. When the temperature of the heating treatment is 250° C. or more, it is possible to obtain the titanium oxide with good crystallinity, the formation of the impurity phase of H₂Ti₈O₁₇ is suppressed, and the electrode capacity, the charging and discharging efficiency and the cycle characteristics become good. Meanwhile, when the temperature of the heating treatment is 500° C. or less, the impurity phase of anatase type TiO₂ is suppressed, and thus, it is possible to prevent the decrease in an electrode capacity due to the impurity phase. The more preferable temperature of the heating treatment is within the range of 300° C. to 400° C.

The time of the heating treatment can be set within the range of 30 minutes or more and 24 hours or less. For example, when the temperature of the heating treatment is set within the range of 300° C. to 400° C., the time of the heating treatment can be set within the range of 1 hour or more and 3 hours or less.

Through the method described above, it is possible to synthesize the titanium oxide with the TiO₂ (B) structure which contains the hetero element. In the titanium oxide with the TiO₂ (B) structure which contains the hetero element and is obtained by the method described above, Li can be preliminarily added by using a Li-containing compound as the starting material. Also, Li can be absorbed by the Li-free titanium oxide with the TiO₂ (B) structure through charging and discharging.

### (Formation of Inorganic Compound Layer)

The method, which coats the inorganic compound layer 10b on the surface of the active material substrate 10a to produce the first active material 10, is not particularly limited, and can be determined according to the material of the active material substrate 10a and the inorganic compound layer 10b.

Hereinafter, the method for coating the inorganic compound layer 10b on the surface of the active material substrate 10a is described by exemplifying the case of forming the inorganic compound layer 10b formed of a metal oxide containing Al or Si on the surface of the active material substrate 10a. The following two methods are exemplified as the method for coating a metal oxide containing Al or Si on the surface of the active material substrate 10a.

### (First Method)

The first method includes: a step in which the powder of the active material substrate 10a is mixed with a metal alkoxide containing Al or Si, to thereby obtain the mixture; and a step in which the mixture is dried to thereby form the inorganic compound layer 10b having the metal oxide containing Al or Si on the surface of the powder of the active material substrate 10a.

By mixing the powder of the active material substrate 10a, the metal alkoxide containing Al or Si, and the appropriate amount of water, it is possible to form the metal oxide precursor on the surface of the powder of the active material substrate 10a. Then, by subjecting the powder to the drying treatment, it is possible to polymerize the metal oxide precursor and to form the inorganic compound layer 10b composed of the metal oxide on the surface of the powder of the active material substrate 10a. This kind of method is referred to as the sol-gel process.

For example, in the case of coating a Si oxide on the surface of the active material substrate 10a as the inorganic compound layer 10b, tetramethoxysilane, tetraethoxysilane or a condensed silicate, etc. is used as the metal alkoxide. Also, in the case of coating an Al oxide on the surface of the active material substrate 10a as the inorganic compound layer 10b, aluminum isopropoxide, etc. is used as the metal alkoxide.

The drying treatment for the active material substrate 10a having the surface, on which the metal oxide precursor is formed, is carried out preferably at a temperature of 25° C. or more and more preferably at a temperature of 50° C. to 250° C. Also, it is desirable that the drying treatment for the active material substrate 10a be carried out in the environment of a low dew point. By doing so, it is possible to prevent an excess amount of the inorganic compound layer 10b from uniformly coating the surface of the active material substrate 10a and to form the inorganic compound layer 10b on the surface of the powder of the active material substrate 10a. Also, by carrying out the drying treatment at the aforementioned temperature desirably in the environment of a low moisture content, it is possible to prevent the moisture and the organic materials in the metal oxide precursor from being evaporated. As a result, the surface of the powder of the active material substrate 10a can be uniformly coated with the inorganic compound layer 10b. It is more preferable that the aforementioned drying treatment be carried out at a temperature of 50° C. to 100° C. in order to more uniformly coat the surface of the active material substrate 10a with the inorganic compound layer 10b.

The aforementioned sol-gel method is particularly suitable when the active material substrate 10a is the titanium oxide with the TiO₂ (B) structure. Because the titanium oxide with the TiO₂ (B) structure has the catalytic action to accelerate the polymerization reaction of the metal alkoxide used as a raw material, there is the advantage in that a catalyst is not need to be added.

### (Second Method)

The second method includes: a step in which the powder of the active material substrate 10a is mixed with the aqueous solution having the compound selected from the hydroxide and chloride containing Al or Si, to thereby obtain the mixed solution; a step in which the pH of the mixed solution is adjusted to 10-14, to thereby make the metal oxide precursor containing Al or Si adhere to the surface of the powder of the active material substrate 10a; a step in which the powder of the active material substrate 10a having the surface, to which the metal oxide precursor adheres, is separated from the mixed solution; and a step in which the powder of the separated active material substrate 10a is dried to thereby form the inorganic compound layer 10b having the metal oxide containing Al or Si on the surface of the powder.

Firstly, the powder of the active material substrate 10a is mixed with the aqueous solution of the hydroxide or chloride containing Al or Si, to thereby obtain the mixed solution. Subsequently, the pH of the mixed solution is adjusted to 10-14, to thereby prepare the metal oxide precursor formed of the hydroxide or chloride containing Al or Si and to make it adhere to the surface of the powder of the active material substrate 10a. Subsequently, the powder is separated from the mixed solution, to thereby obtain the powder of the active material substrate 10a having the surface to which the metal oxide precursor adheres. Subsequently, the powder is subjected to the drying treatment, to thereby polymerize the metal oxide precursor and to form the inorganic compound layer 10b composed of the metal oxide on the surface of the powder of the active material substrate 10a.

This kind of method is referred to as the aqueous solution pH control method. In the aqueous solution pH control method, the hydroxide or chloride containing Al or Si is converted into the hydrate (the metal oxide precursor). This hydrate adheres to the powder of the active material substrate 10a, and then, is polymerized by the dehydration reaction, to thereby form the inorganic compound layer 10b.

The drying treatment in the second method is carried out preferably at a temperature of 20° C. to 250° C. Moreover, in the drying treatment, it is preferable to sufficiently carry out the drying at room temperature and then to carry out the drying at a higher temperature region. By sufficiently carrying out the drying at room temperature and then carrying out the drying at a higher temperature region, it is possible to prevent that the water is rapidly evaporated and the inorganic compound layer 10b is formed in the patchy fashion on the surface of the powder of the active material substrate 10a. It is more preferable that the aforementioned drying treatment be carried out at a temperature of 20° C. to 100° C. in order to more uniformly coat the surface of the active material substrate 10a with the inorganic compound layer 10b.

According to the first and second methods described above, it is possible to coat the inorganic compound layer 10b composed of the metal oxide containing Al or Si on the surface of the active material substrate 10a.

In the first and second methods described above, the mass of the inorganic compound layer 10b (the metal oxide) with respect to the mass of the active material substrate 10a in the first active material 10 can be adjusted by the following method. In other words, the mass of the inorganic compound layer 10b with respect to the mass of the active material substrate 10a can be adjusted by changing the ratio between the active material substrate 10a and the initially added raw materials which become the inorganic compound layer 10b (i.e. water and the metal alkoxide containing Al or Si in the case of the sol-gel method; the aqueous solution of the hydroxide or chloride containing Al or Si in the case of the aqueous solution pH adjustment method), and the treatment condition (i.e. the drying condition in the case of the sol-gel method; the pH adjustment region in the case of the aqueous solution pH adjustment method).

### [Second Active Material]

The second active material 20 is formed of a titanium oxide or a titanate compound, and is basic.

Examples of the basic titanium oxide or titanate compound include Li₄Ti₅O₁₂, and Li₂Ti₃O₇, LiTiNbO₅ and LiTi₃P₃O₁₂, those having the Ramsdellite type structure. Of these, Li₄Ti₅O₁₂ is preferably used as the second active material 20.

The titanium oxide or titanate compound contained in the second active material 20 may be obtained by synthesis from raw materials using a known method or by purchasing commercially available one.

### [Formation of Carbon Coating Layer]

As the method for coating the carbon coating layer 18 on the surface of the second active material 20, a conventionally known method can be used, and for example, it is possible to use the method described below.

In order to coat the carbon coating layer 18 on the surface of the basic second active material 20, firstly, the carbon source of the carbon coating layer 18 is prepared. As the carbon source, an aqueous solution of a predetermined concentration containing carbohydrates at a predetermined amount is prepared. Then, the second active material 20 and the aqueous solution containing carbohydrates are mixed and dried to the extent that water is evaporated, and thereafter, the thermal treatment is carried out in an inert atmosphere. Through this process, the carbon coating layer 18 is formed on the surface of the second active material 20.

When the second active material 20 is formed of Li₄Ti₅O₁₂, the crystal structure of Li₄Ti₅O₁₂ is less likely to change even if the thermal treatment for the formation of the carbon coating layer 18 is carried out. Therefore, it is possible to determine the conditions of the thermal treatment for the formation of the carbon coating layer 18 without considering the effect on the crystal structure of Li₄Ti₅O₁₂. For example, the temperature of the thermal treatment can be set to 700-1000° C. and preferably to 700-900° C. When the temperature of the thermal treatment is 700° C. or more, it is possible to prevent that the organic materials remaining in the carbon coating layer 18 cause the increase in the internal resistance of the nonaqueous electrolyte battery obtained by using the active material of the present embodiment.

The battery active material of the aforementioned embodiment includes the first active material 10 obtained by coating the surface of the active material substrate 10a with the inorganic compound layer 10b, and the basic second active material 20, wherein the surface of the second active material 20 is covered with the carbon coating layer 18 composed of carbon. Therefore, the contact between the inorganic compound layer 10b in the battery active material and the basic second active material 20 can be prevented by the carbon coating layer 18. For this reason, the inorganic compound layer 10b can stably exist in the battery active material, and it is possible to suppress the reactivity of the active material substrate 10a to a nonaqueous electrolyte. As a result, the resistance increase is suppressed, and the battery active material can realize a nonaqueous electrolyte battery having improved cycle lifespan.

### Second Embodiment

FIG. 2 is a schematic diagram for explaining a battery active material of the second embodiment. The battery active material shown in FIG. 2 includes the first active material 10 and the second active material 20. The first active material 10 contains an active material substrate 10a and an inorganic compound layer 10b covering the surface of the active material substrate 10a. The active material substrate 10a is formed of a titanium oxide or a titanate compound, and is neutral or acidic. The second active material 20 is formed of a titanium oxide or a titanate compound 20a, and is basic.

The different part between the battery active material shown in FIG. 2 and the battery active material shown in FIG. 1 is as follows. In the battery active material shown in FIG. 1, the surface of the second active material 20 is covered with the carbon coating layer 18. By contrast, in the battery active material shown in FIG. 2, the surface of the first active material 10 is covered with the carbon coating layer 18.

The mass (coating amount) of the carbon coating layer 18 is preferably within the range of 0.1 to 3 mass % ((carbon coating layer/second active material)×100) of the mass of the first active material 10, and more preferably the range of 0.5 to 2.5 mass %. When the coating amount is 0.1 mass % or more, it is possible to sufficiently suppress the adverse effect of the basic second active material 20 to the inorganic compound layer 10b. When the coating amount is 3 mass % or less, the carbon coating layer 18 rarely suppresses that Li, which exists on the surface of the first active material 10, diffuses into the active material, which is preferred. Also, when the coating amount is 3 mass % or less, because a specific surface area is increased by providing the carbon coating layer 18, the improvement in electrode density is not suppressed in a rolling process after the production of an electrode, which is preferred.

The thickness of the carbon coating layer 18 is preferably within the range of 10 to 1000 nm. When the thickness of the carbon coating layer 18 is within the aforementioned range, it is possible to sufficiently suppress the adverse effect to the inorganic compound layer 10b which occurs by the contact between the basic second active material 20 and the inorganic compound layer 10b. In order to more efficiently suppress the adverse effect of the basic second active material 20 to the inorganic compound layer 10b, the thickness of the carbon coating layer 18 is more preferably set to 100 nm or more. Also, when the thickness of the carbon coating layer 18 is within the aforementioned range, it is possible to suppress that the function as a battery active material of the first active material 10 is deteriorated by the coating with the carbon coating layer 18. In order to further suppress the decrease in the function as a battery active material of the first active material 10, the thickness of the carbon coating layer 18 is more preferably set to 800 nm or less.

The thickness of the carbon coating layer 18 formed on the surface of the first active material 10 complies with the aforementioned definition of the thickness of the carbon coating layer formed on the surface of the second active material 20. When the first active material to be subjected to cross-sectional observation is obtained in the state of the first active material, the thickness of the carbon coating layer 18 is measured by the cross-sectional observation thereof When the first active material to be subjected to cross-sectional observation is obtained in the state of an electrode, the mixed powder of the battery active material and a conductive agent is obtained by the aforementioned method for extracting the battery active material from an electrode. By subjecting the mixed powder of the active material derived from an electrode and a conductive agent, or the single active material to cross-sectional SEM observation or cross-sectional TEM observation, it is possible to detect the carbon existing on the first active material. In the same manner as the carbon coating layer formed on the surface of the second active material 20, it is possible to distinguish the carbon material used for a conductive agent and the carbon coating layer which was intentionally coated on the surface of the first active material.

The thickness of the carbon coating layer coated on the surface of the first active material can be measured by the method described below. Firstly, the cross-section of the first active material 10 having the surface coated with the carbon coating layer is observed by SEM or TEM. Then, 5 to 10 particles are selected from among the particles whose cross-sections corresponding to average particle sizes have been observed by SEM or TEM, and are subjected to the measurement of the distance from the interface between the active material and the carbon coating to the outer surface of the carbon coating layer. Then, the average value of the measurement results is defined as the thickness of the carbon coating layer formed on the surface of the first active material.

### [Formation of Carbon Coating Layer]

As the method for coating the carbon coating layer 18 on the surface of the first active material 10, a conventionally known method can be used, and for example, it is possible to use the method described below.

In order to coat the carbon coating layer 18 on the surface of the first active material 10, firstly, the carbon source of the carbon coating layer 18 is prepared. As the carbon source, an aqueous solution of a predetermined concentration containing carbohydrates at a predetermined amount is prepared. Then, the first active material 10 and the aqueous solution containing carbohydrates are mixed and dried to the extent that water is evaporated, and thereafter, the thermal treatment is carried out in an inert atmosphere. Through this process, the carbon coating layer 18 is formed on the surface of the first active material 10.

When the active material substrate 10a of the first active material 10 is formed of TiO₂ (B) and the temperature of the thermal treatment for the formation of the carbon coating layer 18 exceeds 400° C., the crystal structure of TiO₂ (B) is partially changed into anatase, and there is a possibility that the capacity decreases. However, when the temperature of the thermal treatment is low, it significantly appears that the characteristics of a nonaqueous electrolyte battery are deteriorated by the organic materials remaining in the carbon coating layer 18. For these reasons, it is preferable to carry out the thermal treatment at a high temperature range to some extent even when the active material substrate 10a is TiO₂ (B). Specifically, the temperature of the thermal treatment for the formation of the carbon coating layer 18 is set preferably to 700-1000° C. and more preferably to 700-900° C. When the temperature of the thermal treatment is 700° C. or more, it is possible to prevent that the organic materials remaining in the carbon coating layer 18 cause the increase in the internal resistance of the nonaqueous electrolyte battery obtained by using the battery active material of the present embodiment.

The battery active material of the second embodiment includes the first active material 10 obtained by coating the surface of the active material substrate 10a with the inorganic compound layer 10b, and the basic second active material 20, wherein the surface of the first active material 10 is covered with the carbon coating layer 18 composed of carbon. Therefore, the contact between the inorganic compound layer 10b in the battery active material and the first active material 10 can be prevented by the carbon coating layer 18. For this reason, the inorganic compound layer 10b can stably exist in the battery active material, and it is possible to suppress the reactivity of the active material substrate 10a to a nonaqueous electrolyte. As a result, the resistance increase is suppressed, and the battery active material can realize a nonaqueous electrolyte battery having improved cycle lifespan.

The first and second embodiments have been described by exemplifying the case of coating either the first active material 10 or the second active material 20 with the carbon coating layer 18, but both of the first active material 10 or the second active material 20 can be coated with the carbon coating layer 18.

Also, each of the first active material 10 and the second active material 20 can be formed of one type of the battery active material or two or more types of the battery active material.

### Third Embodiment

Next, a nonaqueous electrolyte battery according to a third embodiment will be described.

The nonaqueous electrolyte battery according to the embodiment includes at least a positive electrode, the negative electrode containing the battery active material according to the first embodiment or the second embodiment, and a nonaqueous electrolyte. More specifically, the nonaqueous electrolyte battery according to the embodiment includes an external material, a positive electrode that is accommodated inside the external material, a negative electrode that is spatially separated from the positive electrode inside the external material, is accommodated with, for example, a separator interposed therebetween, and includes the foregoing battery active material, and a nonaqueous electrolyte with which the inside of the external material is filled.

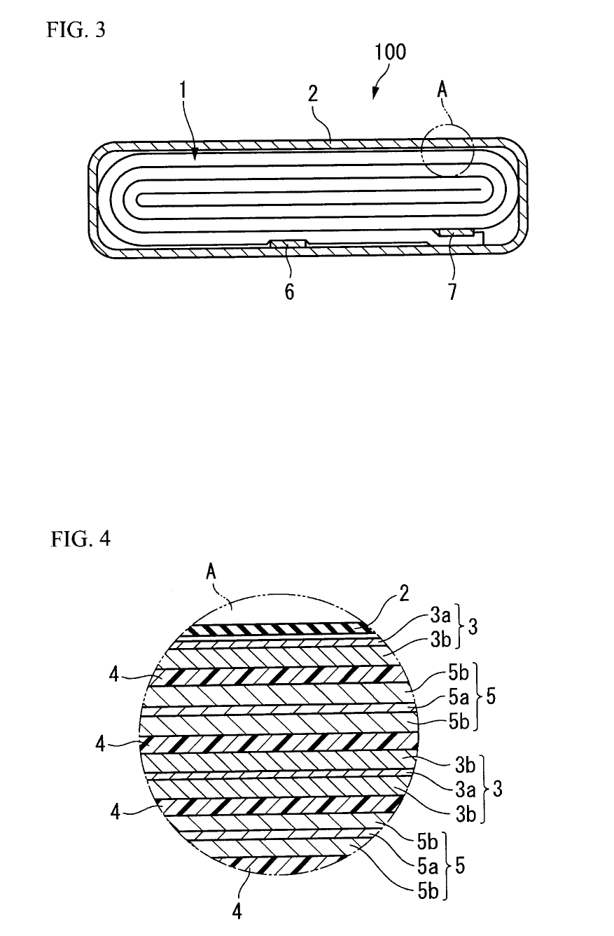

Hereinafter, a flat type nonaqueous electrolyte battery (nonaqueous electrolyte battery) 100 illustrated in FIGS. 3 and 4 will be described as an example of the nonaqueous electrolyte battery according to the embodiment. FIG. 3 is a schematic sectional view illustrating the cross-section of the flat type nonaqueous electrolyte battery 100. FIG. 4 is an enlarged sectional view illustrating a part A illustrated in FIG. 3.

These drawings are schematic diagrams for describing the nonaqueous electrolyte battery according to the embodiment. The shapes, dimensions, ratios, and the like are different from those of actual device in some portions, but design of the shape, dimensions, ratios, and the like can be appropriately modified in consideration of the following description and known technologies.

The flat type nonaqueous electrolyte battery 100 illustrated in FIG. 3 is configured such that a winding electrode group 1 with a flat shape is accommodated inside an exterior material 2. The exterior material 2 may be made by forming a laminated film in a bag-like shape or may be a metal container. The winding electrode group 1 with the flat shape is formed by spirally winding a laminate laminated from the outside, i.e., the side of the exterior material 2, in the order of a negative electrode 3, a separator 4, a positive electrode 5, and the separator 4 and performing press-molding. As illustrated in FIG. 4, the negative electrode 3 located at the outermost periphery has a configuration in which a negative electrode layer 3b is formed on one side of the inner surface of a negative current collector 3a. The negative electrodes 3 of portions other than the outermost periphery have a configuration in which the negative electrode layers 3b are formed on both surfaces of the negative current collector 3a. In the flat type nonaqueous electrolyte battery 100 according to the embodiment, the negative electrode active material in the negative electrode layer 3b is configured to include the battery active material according to the first embodiment or the second embodiment. The positive electrode 5 has a configuration in which positive electrode layers 5b are formed on both surfaces of a positive current collector 5a. A gel-like nonaqueous electrolyte to be described below may be used instead of the separator 4.

In the winding electrode group 1 illustrated in FIG. 3, in the vicinity of the outer peripheral end thereof, a negative electrode terminal 6 is electrically connected to the negative current collector 3a of the negative electrode 3 of the outermost periphery. A positive electrode terminal 7 is electrically connected to the positive current collector 5a of the inside positive electrode 5, as illustrated in FIG. 4. The negative electrode terminal 6 and the positive electrode terminal 7 extend toward the outer portion of the exterior material 2 with the bag-like shape and are connected to extraction electrodes included in the exterior material 2.

When the nonaqueous electrolyte battery 100 including an exterior material formed of the laminated film is manufactured, the exterior material 2 with the bag-like shape having an opening is charged with the winding electrode group 1 to which the negative electrode terminal 6 and the positive electrode terminal 7 are connected, the liquid nonaqueous electrolyte is injected from the opening of the exterior material 2, and the opening of the exterior material 2 with the bag-like shape is subjected to heat-sealing with the negative electrode terminal 6 and the positive electrode terminal 7 interposed therebetween, so that the winding electrode group 1 and the liquid nonaqueous electrolyte are completely sealed.

When the nonaqueous electrolyte battery 100 having an exterior material formed of a metal container is manufactured, the metal container having an opening is charged with the winding electrode group 1 to which the negative electrode terminal 6 and the positive electrode terminal 7 are connected, the liquid nonaqueous electrolyte is injected from the opening of the exterior material 2, and the opening is sealed by mounting a cover member on the metal container.

For the negative electrode terminal 6, for example, a material having electric stability and conductivity within the range of a potential equal to or nobler than 1 V and equal to or lower than 3 V with respect to lithium can be used. Specifically, examples of this material include aluminum and an aluminum alloy containing an element such as Mg, Ti, Zn, Mn, Fe, Cu, or Si. The negative electrode terminal 6 may be more preferably formed of the same material as the negative current collector 3a in order to reduce contact resistance with the negative current collector 3a.

For the positive electrode terminal 7, a material having electric stability and conductivity within the range of a potential from 3 V to 4.25 V with respect to lithium can be used. Specifically, examples of this material include aluminum and an aluminum alloy containing an element such as Mg, Ti, Zn, Mn, Fe, Cu, or Si. The positive electrode terminal 7 may be more preferably formed of the same material as the positive current collector 5a in order to reduce contact resistance with the positive current collector 5a.

Hereinafter, the exterior material 2, the negative electrode 3, the positive electrode 5, the separator 4, and the nonaqueous electrolyte which are constituent members of the nonaqueous electrolyte battery 100 will be described in detail.

### (1) Exterior Material

The exterior material 2 is formed of a laminated film with a thickness equal to or less than 0.5 mm, or a metal container with a thickness equal to or less than 1.0 mm is used.

The shape of the exterior material 2 can be appropriately selected from a flat type (thin type), a square type, a cylindrical type, a coin type, and a button type.

Examples of the exterior material 2 include an exterior material for a small-sized battery mounted on a portable electronic apparatus and an exterior material for a large-sized battery mounted on a two-wheeled or four-wheeled vehicle or the like according to the dimensions of the battery.

When the exterior material 2 formed of a laminated film is used, a multi-layer film in which a metal layer is interposed between resin layers is used. In this case, in the metal layer, it is preferable to utilize an aluminum foil or an aluminum alloy foil for weight reduction. For example, a polymer material such as polypropylene (PP), polyethylene (PE), nylon, or polyethylene terephthalate (PET) can be used as the resin layer. The laminated film can be molded in the shape of the exterior material by performing sealing by heat sealing.

When the exterior material 2 formed of a metal container is used, the metal container formed of aluminum, an aluminum alloy, or the like is used. As such an aluminum alloy, an alloy containing an element such as magnesium, zinc, or silicon is preferably used. When transition metal such as iron, copper, nickel, or chromium is contained in the aluminum alloy, it is preferable to suppress an amount of the transition metal to 100 or less mass ppm. When the exterior material 2 formed of a metal container is used, it is more preferable to use the metal container with a thickness equal to or less than 0.5 mm.

### (2) Negative Electrode

The negative electrode 3 includes the current collector 3a and the negative electrode layer 3b that is formed on one side or both sides of the current collector 3a and includes a negative electrode active material, a conducting agent, and a binding agent.

The battery active material according to the above-described first embodiment or second embodiment is used as the negative electrode active material.

In the nonaqueous electrolyte battery 100, into which the negative electrode 3 including the negative electrode layer 3b containing the battery active material is embedded, the increase in resistance is suppressed, and the cycle life is improved.

The conducting agent improves the current collection performance of the negative electrode active material and suppresses contact resistance between the negative electrode active material and the negative current collector 3a. Examples of the conducting agent include agents containing acetylene black, carbon black, coke, a carbon fiber, and graphite.

The binding agent fills gaps between the dispersed negative electrode active material to bind the negative active material and the conducting agent and bind the negative electrode active material and the negative current collector 3a. Examples of the binding agent include agents containing polytetrafluoroethylene (PTFE), polyvinylidene fluoride (PVdF), fluorine-based rubber, styrene-butadiene rubber (SBR), an ethylene-propylene-diene copolymer (EPDM), and carboxymethyl cellulose (CMC).

In the negative electrode layer 3b, the negative electrode active material, the conducting agent, and the binding agent are preferably mixed at ratios of 68% by mass or more and 96% by mass or less, 2% by mass or more and 30% by mass or less, and 2% by mass or more and 30% by mass or less, respectively. The negative electrode active material, the conducting agent, and the binding agent are more preferably mixed at ratios of 70% by mass or more and 96% by mass or less, 2% by mass or more and 28% by mass or less, and 2% by mass or more and 28% by mass or less, respectively.

By setting the amount of the conducting agent to be 2% by mass or more, it is possible to prevent the basic second active material 20 and the direct contact between the inorganic compound layer 10b covering the surface of the first active material 10. Also, it is possible to improve the current collection performance of the negative layer 3b.

Also, by setting the amount of binding agent to be 2% by mass or more, the binding property of the negative electrode layer 3b and the current collector 3a can be improved and the cycle characteristics can be improved.

On the other hand, in terms of a large capacity, it is preferable to set the conducting agent and the binding agent to be 30% by mass or less and it is more preferable to set the conducting agent and the binding agent to be 28% by mass or less.

The negative current collector 3a is preferably an aluminum foil which is electrochemically stable within a potential range of nobler than 1 V (for example 1 to 1.4 V) or an aluminum alloy foil containing an element such as Mg, Ti, Zn, Mn, Fe, Cu, or Si. The thickness of the negative current collector 3a is preferably within the range of 8 μm to 25 μm and is more preferably within the range of 5 μm to 20 μm. In addition to the above foil, a stainless foil, a titanium foil, a copper foil, a nickel foil, or the like can be used as the negative current collector 3a. For example, when a negative electrode potential is nobler than 0.3 V with respect to metal lithium or a lithium-titanium oxide is used as the negative electrode active material, it is preferable to use the foregoing aluminum foil or aluminum alloy foil since the battery weight can be suppressed.

When the foregoing aluminum foil is used as the negative current collector 3a, the purity of the aluminum foil is preferably 99% or more.

When the foregoing aluminum alloy foil is used as the negative current collector 3a, it is preferable to suppress a content of a transition metal such as Fe or Cu to 1% by mass or less.

The negative electrode 3 can be produced, for example, by suspending the negative electrode active material, the conducting agent, and the binding agent in a general solvent to prepare a slurry, applying the slurry to the negative current collector 3a and performing drying, and then performing pressing. The negative electrode 3 may be produced by forming the negative electrode active material, the conducting agent, and the binding agent in a pellet form to make the negative electrode layer 3b, and disposing and forming the negative electrode layer 3b on the negative current collector 3a.

### (3) Positive Electrode

The positive electrode 5 includes the positive current collector 5a and the positive electrode layer 5b that is formed on one side or both sides of the positive current collector 5a and includes a positive electrode active material, a conducting agent, and a binding agent. For example, an oxide, a sulfide, or a polymer can be used as the positive electrode active material.

As the oxide used for the positive electrode active material, for example, manganese dioxide (MnO₂) in which lithium is occluded, an iron oxide, a copper oxide, a nickel oxide, a lithium-manganese composite oxide (for example, LiₓMn₂O₄ or LiₓMnO₂), a lithium-nickel composite oxide (for example, LiₓNiO₂), a lithium-cobalt composite oxide (LiₓCoO₂), a lithium-nickel-cobalt composite oxide (for example, LiNi_{1-y}Co_{y}O₂), a lithium-manganese-cobalt composite oxide (for example, LiₓMn_{y}Co_{1-y}O₂), a lithium-manganese-nickel composite oxide (LiₓMn_{2-y}Ni_{y}O₄) having a spinel structure, a lithium-phosphorus oxide (for example, LiₓFePO₄, LiₓFe_{1-y}Mn_{y}PO₄, or LiₓCoPO₄) having an olivine structure, iron sulfate (Fe₂(SO₄)₃), or a vanadium oxide (for example, V₂O₅) can be used. In each of the foregoing chemical formulae, x and y preferably satisfy the relational expressions of “0<x≦1” and “0≦y≦1,” respectively.

As a polymer used for the positive electrode active material, for example, a conductive polymer material such as polyaniline or polypyrrole or a disulfide-based polymer material can be used.

An inorganic material or an organic material such as sulfur (S) or carbon sulfide can also be used as the positive electrode active material.

Of the above examples, examples of the preferable positive electrode active materials include a lithium-manganese composite oxide (LiₓMn₂O₄), a lithium-nickel composite oxide (LiₓNiO₂), a lithium-cobalt composite oxide (LiₓCoO₂), a lithium-nickel-cobalt composite oxide (LiNi_{1-y}Co_{y}O₂), a lithium-manganese-nickel composite oxide (LiₓMn_{2-y}Ni_{y}O₄) having a spinel structure, a lithium-manganese-cobalt composite oxide (LiₓMn_{y}Co_{1-y}O₂), and a lithium iron phosphate (LiₓFePO₄) with a high positive electrode voltage. In each of the foregoing chemical formulae, x and y preferably satisfy the relational expressions of “0<x≦1” and “0≦y1,” respectively.

Of these, examples of the more preferable positive electrode active materials include a lithium-cobalt composite oxide and a lithium-manganese composite oxide. Since such a positive electrode active material has high ion conductivity, diffusion of lithium ions in the positive electrode active material rarely enters a rate-controlling step in combination of the above-described negative electrode active material. Therefore, the positive electrode active material including the foregoing composition has excellent compatibility with a lithium-titanium composite oxide in the negative electrode active material.

When an ambient temperature molten salt is used as the nonaqueous electrolyte, it is preferable to use a lithium iron phosphate, LiₓVPO₄F, a lithium-manganese composite oxide, a lithium-nickel composite oxide, or a lithium-nickel-cobalt composite oxide in terms of a cycle lifespan. This is because reactivity between the positive electrode active material and the ambient temperature molten salt is small.

The conducting agent improves the current collection performance of the positive electrode active material and suppresses contact resistance between the positive electrode active material and the positive current collector 5a. Examples of the conducting agent include agents containing acetylene black, carbon black, artificial graphite, natural graphite, and a conductive polymer.

The binding agent fills gaps between the dispersed positive electrode active material to bind the positive active material and the conducting agent and bind the positive electrode active material and the positive current collector 5a. Examples of the binding agent include agents containing polytetrafluoroethylene (PTFE), polyvinylidene fluoride (PVdF), and fluorine-based rubber. As the binding agent, modified PVdF substituted with at least another substituent, a copolymer of vinylidene fluoride and propylene hexafluoride, and a terpolymer of polyvinylidene fluoride, tetrafluoroethylene, and propylene hexafluoride can be used in association with the above materials.

For example, N-methyl-2-pyrrolidone (NMP) or dimethylformamide (DMF) can be used as an organic solvent dispersing the binding agent.

In the positive electrode layer 5b, the positive electrode active material and the binding agent are preferably mixed at ratios of 80% by mass or more and 98% by mass or less, and 2% by mass or more and 20% by mass, or less respectively. By setting the amount of binding agent to be 2% by mass or more, sufficient electrode intensity can be obtained. By setting the amount of binding agent included in the positive electrode layer 5b to be 20% by mass or less, it is possible to reduce a mixture amount of insulator of the electrode and reduce internal resistance.

When the conducting agent is added to the positive electrode layer 5b, the positive electrode active material, the conducting agent, and the binding agent are mixed at ratios of 77% by mass or more and 95% by mass or less, 2% by mass or more and 20% by mass or less, and 3% by mass or more and 15% by mass or less, respectively, and are more preferably mixed at ratios of 80% by mass or more and 95% by mass or less, 3% by mass or more and 18% by mass or less, and 2% by mass or more and 17% by mass or less, respectively.

By setting a content of the conducting agent to be 2% by mass or more and preferably 3% by mass or more, it is possible to obtain the above-described advantages. By setting the content of the conducting agent to be 20% by mass or less and preferably 18% by mass or less, it is possible to reduce decomposition of the nonaqueous electrolyte on the conductive agent surface in high temperature preservation.

The positive current collector 5a is preferably, for example, an aluminum foil or an aluminum alloy foil containing an element such as Mg, Ti, Zn, Mn, Fe, Cu, or Si. A stainless foil, a titanium foil, or the like can also be used as the positive current collector 5a. The thickness of the positive current collector 5a is preferably within the range of 8 μm to 25 μm.

When the foregoing aluminum foil is used as the positive current collector 5a, the purity of the aluminum foil is preferably 99% or more.

When the foregoing aluminum alloy foil is used as the positive current collector 5a, it is preferable to suppress a content of a transition metal such as Fe or Cu to 1% by mass or less.

The positive electrode 5 can be produced, for example, by suspending the positive electrode active material, the conducting agent, and the binding agent in a general solvent to prepare a slurry, applying the slurry to the positive current collector 5a and performing drying, and then performing pressing. The positive electrode 5 may be produced by forming the positive electrode active material, the conducting agent, and the binding agent in a pellet form to make the positive electrode layer 5b, and disposing and forming the positive electrode layer 5b on the positive current collector 5a.

### (4) Nonaqueous Electrolyte

For example, a liquid nonaqueous electrolyte prepared by dissolving a solute in an organic solvent or a gel-like nonaqueous electrolyte in which a liquid electrolyte and a polymer material are composited can be used as the nonaqueous electrolyte.

As the liquid nonaqueous electrolyte, it is desirable to use an electrolyte obtained by dissolving a solute in an organic solvent at a density equal to or greater than 0.5 mol/L and equal to or less than 2.5 mol/L.

One or more kinds of lithium salts selected from lithium perchlorate (LiClO₄), lithium hexafluorophosphate (LiPF₆), lithium tetrafluoroborate (LiBF₄), lithium hexafluoroarsenate (LiAsF₆), lithium trifluoromethanesulfonate (LiCF₃SO₃), lithium bistrifluoromethylsulfonimide [LiN(CF₃SO₂)₂], [LiN(C₂F₅SO₂)₂], [Li(CF₃SO₂)₃C], and LiB[(OCO)₂]₂ is preferable as an example of the solute. The lithium salt is dissolved in an organic solvent at a density within the range of 0.5 mol/L to 2 mol/L to make an organic electrolytic solution.

A solute which is rarely oxidized at a high potential is preferably used and LiPF₆ is most preferably used.

Examples of the organic solvent include cyclic carbonates such as propylene carbonate (PC), ethylene carbonate (EC), or vinylene carbonate, chain carbonates such as diethyl carbonate (DEC), dimethyl carbonate (DMC), and methylethyl carbonate (MEC), cyclic ethers such as tetrahydrofuran (THF), 2-methyltetrahydrofuran (2MeTHF), and dioxolane (DOX), chain ethers such as dimethoxyethane (DME) and diethoxyethane (DEE), and γ-butyrolactone (GBL), acetonitrile (AN), and sulfolane (SL). Such organic solvents can be used solely or in a mixed solvent form.

Of the above examples, a mixed solvent in which at least two solvents are mixed from the group of propylene carbonate (PC), ethylene carbonate (EC), and diethyl carbonate (DEC) or a mixed solvent containing γ-butyrolactone (GBL) can be used as a preferable organic solvent. By using such a mixed solvent, it is possible to obtain a nonaqueous electrolyte battery having excellent high-temperature characteristics.

Examples of the polymer material forming the gel-like nonaqueous electrolyte include materials containing polyvinylidene fluoride (PVdF), polyacrylonitrile (PAN), and polyethylene oxide (PEO).

An ambient temperature molten salt (ionic melt) containing lithium ions can also be used as the nonaqueous electrolyte. For example, when an electrolyte which is an ionic melt formed of lithium ions, organic cations and anions and is a liquid at a temperature equal to or less than 100° C. and preferably at a temperature equal to or less than room temperature is selected as the nonaqueous electrolyte, it is possible to obtain the nonaqueous electrolyte battery with a broad range of operation temperatures.

### (5) Separator

As the separator 4, for example, a porous film containing polyethylene, polypropylene, cellulose, or polyvinylidene fluoride (PVdF) or a nonwoven fabric made of a synthetic resin can be used. As the porous film appropriately used for the separator 4, a film made of polyethylene, polypropylene, or both thereof can be used. The separator 4 formed of such a material is preferable since, when a battery temperature increases and reaches a given temperature, the separator 4 is melted, so that a shutdown function of blocking pores and considerably attenuating a charging and discharging current is easily added and stability of the nonaqueous electrolyte battery can be improved.

In terms of reducing cost, the separator 4 formed of a cellulose-based material may be used.

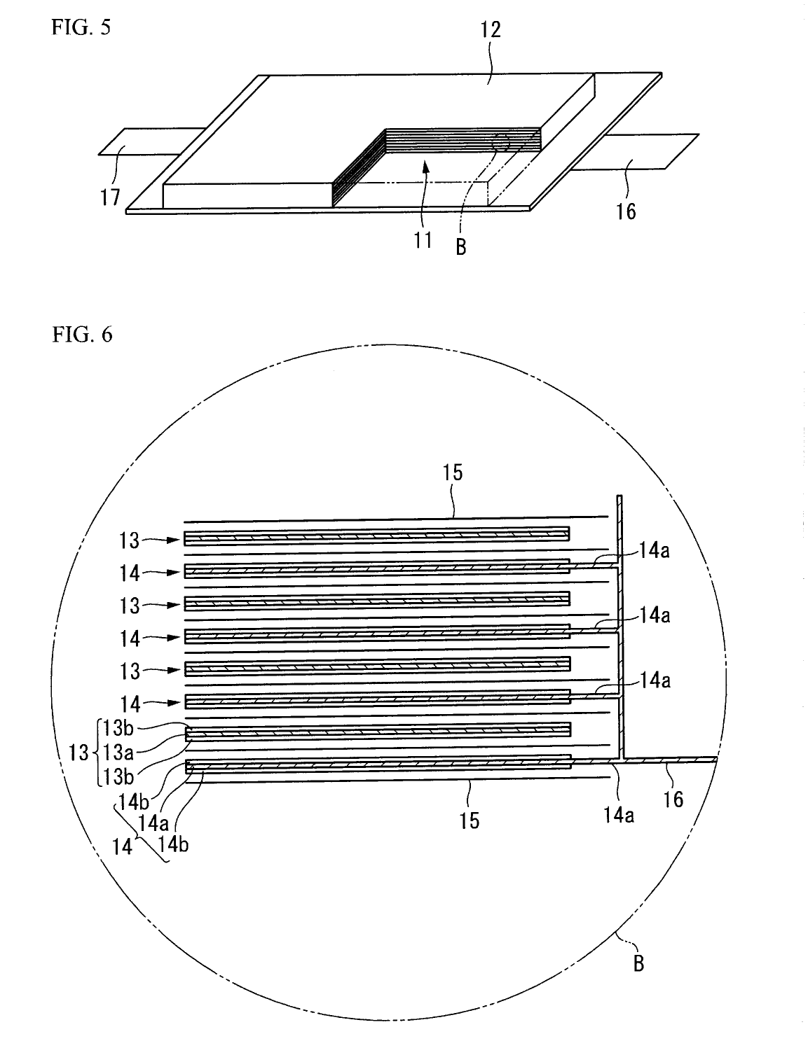

The configuration of the nonaqueous electrolyte battery according to the third embodiment is not limited to the above-described configuration illustrated in FIGS. 3 and 4. For example, a nonaqueous electrolyte battery having a configuration illustrated in FIGS. 5 and 6 may be used. FIG. 5 is a partial cutout perspective view schematically illustrating another flat type nonaqueous electrolyte secondary battery according to the second embodiment. FIG. 6 is an enlarged schematic sectional view illustrating a part B of FIG. 5.

The nonaqueous electrolyte battery illustrated in FIGS. 5 and 6 is configured such that a lamination type electrode group 11 is accommodated inside an exterior member 12. As illustrated in FIG. 6, the lamination type electrode group 11 has a structure in which positive electrodes 13 and negative electrodes 14 are alternately laminated with separators 15 interposed therebetween.

As illustrated in FIG. 6, the plurality of positive electrodes 13 are present and each include a positive current collector 13a and positive electrode layers 13b supported on both surfaces of the positive current collector 13a. The positive electrode layer 13b contains a positive electrode active material.

As illustrated in FIG. 6, as in the positive electrodes 13, the plurality of negative electrodes 14 are present and each includes a negative current collector 14a and negative electrode layers 14b supported on both surfaces of the negative current collector 14a. The negative electrode layer 14b contains the negative electrode active material. The negative electrode active material contains the battery active material having the configuration of the first embodiment or the second embodiment. One side of the negative current collector 14a of each negative electrode 14 protrudes from the negative electrode 14. The protruding negative current collector 14a is electrically connected to a strip-shaped negative electrode terminal 16. The front end of the strip-shaped negative electrode terminal 16 is drawn from the exterior member 12 to the outside.

Although not illustrated, the side of the positive current collector 13a of the positive electrode 13 located opposite to the protruding side of the negative current collector 14a protrudes from the positive electrode 13. The positive current collector 13a protruding from the positive electrode 13 is electrically connected to a strip-shaped positive electrode terminal 17. The front end of the strip-shaped positive electrode terminal 17 is located on an opposite side to the negative electrode terminal 16 and is drawn from a side of the exterior member 12 to the outside.

The material, a mixture ratio, dimensions, and the like of each member included in the nonaqueous electrolyte battery illustrated in FIGS. 5 and 6 are configured to be the same as those of each constituent member of the nonaqueous electrolyte battery 100 described in FIGS. 3 and 4.

In the above-described embodiment, it is possible to provide the nonaqueous electrolyte battery having excellent charging and discharging cycle performance.

### Fourth Embodiment

Next, a battery pack according to a fourth embodiment will be described in detail.

The battery pack according to the embodiment includes at least one nonaqueous electrolyte battery (that is, a single battery) according to the foregoing third embodiment. When the plurality of single batteries are included in the battery pack, the single batteries are electrically connected in series, in parallel, or in series and parallel to be disposed.

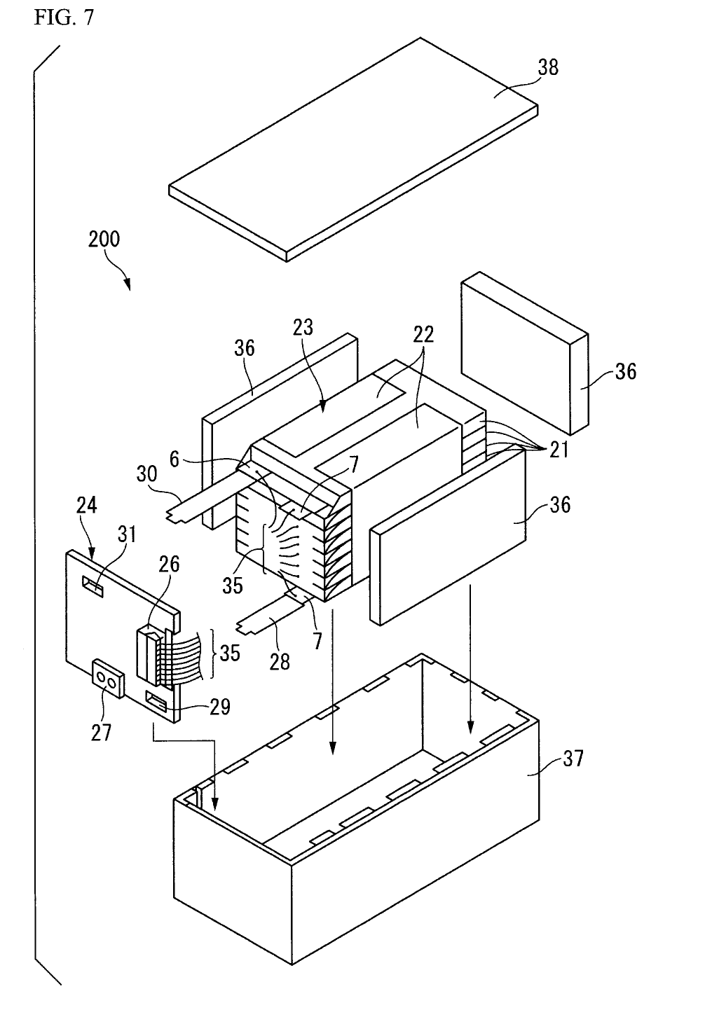

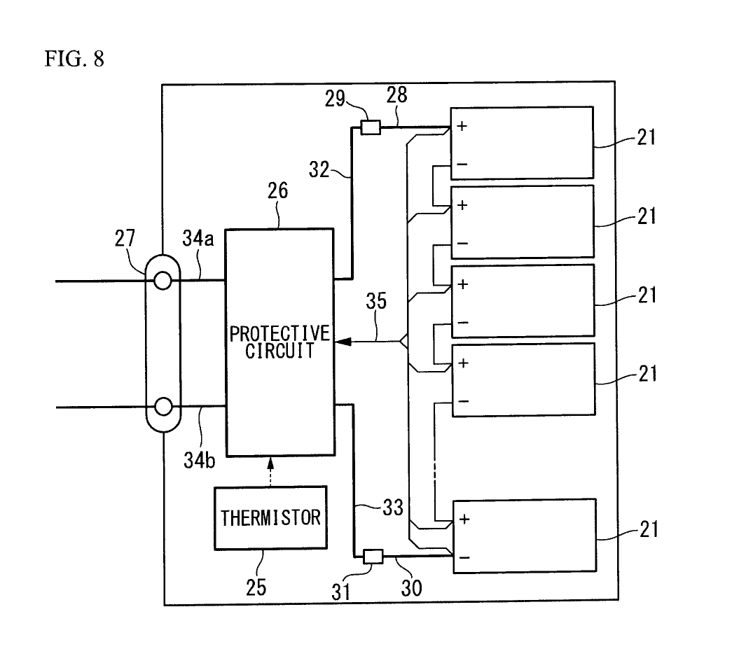

Referring to FIGS. 7 and 8, a battery pack 200 according to the embodiment will be described specifically. In the battery pack 200 illustrated in FIG. 7, the flat type nonaqueous electrolyte battery 100 illustrated in FIG. 3 is used as a single battery 21.

The plurality of single batteries 21 are laminated so that the negative electrode terminals 6 and the positive electrode terminals 7 extending to the outside are arranged in the same direction, and thus assembled batteries 23 are configured by fastening using an adhesive tape 22. The single batteries 21 are mutually connected electrically in series, as illustrated in FIGS. 7 and 8.

A printed wiring board 24 is disposed to face the side surfaces of the single batteries 21 in which the negative electrode terminals 6 and the positive electrode terminals 7 extend. As illustrated in FIG. 7, a thermistor 25 (see FIG. 8), a protective circuit 26, and an electrifying terminal 27 to an external device are mounted on the printed wiring board 24. An insulation plate (not illustrated) is mounted on the surface of the printed wiring board 24 facing the assembled batteries 23 in order to avoid unnecessary connection with wirings of the assembled batteries 23.

A positive-side lead 28 is connected to the positive electrode terminal 7 located in the lowermost layer of the assembled batteries 23 and the front end of the positive electrode-side lead 28 is inserted into a positive electrode-side connector 29 of the printed wiring board 24 to be electrically connected. A negative electrode-side lead 30 is connected to the negative electrode terminal 6 located in the uppermost layer of the assembled batteries 23 and the front end of the negative electrode-side lead 30 is inserted into a negative electrode-side connector 31 of the printed wiring board 24 to be electrically connected. These connectors 29 and 31 are connected to the protective circuit 26 via wirings 32 and 33 (see FIG. 8) formed in the printed wiring board 24.

The thermistor 25 is used to detect a temperature of the single battery 21. Although not illustrated in FIG. 7, the thermistor 25 is installed near the single batteries 21 and a detection signal is transmitted to the protective circuit 26. The protective circuit 26 blocks a plus-side wiring 34a and a minus-side wiring 34b between the protective circuit 26 and the electrifying terminal 27 connected to an external device under a predetermined condition. Here, for example, the predetermined condition is that the detection temperature of the thermistor 25 be equal to or greater than a predetermined temperature. The predetermined condition is also that an overcharge, overdischarge, overcurrent, or the like of the single battery 21 be detected. The detection of the overcharge or the like is performed for the individual single batteries 21 or all of the single batteries 21. When the overcharge or the like is detected in the individual single batteries 21, a battery voltage may be detected, or a positive electrode potential or a negative electrode potential may be detected. In the latter case, lithium electrodes used as reference poles are inserted into the individual single batteries 21. In the case of FIGS. 7 and 8, wirings 35 are connected to detect the respective voltages of the single batteries 21 and detection signals are transmitted to the protective circuit 26 via the wirings 35.

As illustrated in FIG. 7, protective sheets 36 formed of rubber or resin are disposed on three side surfaces of the assembled batteries 23 excluding the side surface from which the positive electrode terminals 7 and the negative electrode terminals 6 protrude.

The assembled batteries 23 are accommodated along with the protective sheets 36 and the printed wiring board 24 inside an accommodation container 37. That is, the protective sheets 36 are disposed on both of the inner surfaces of the accommodation container 37 in the longer side direction and the inner surface in the shorter side direction, and the printed wiring board 24 is disposed on the inner surface opposite to the protective sheet 36 in the shorter side direction. The assembled batteries 23 are located in a space surrounded by the protective sheets 36 and the printed wiring board 24. A cover 38 is mounted on the upper surface of the accommodation container 37.

When the assembled batteries 23 are fixed, a thermal shrinkage tape may be used instead of the adhesive tape 22. In this case, protective sheets are disposed on both side surfaces of the assembled batteries, the thermal shrinkage tape is circled, and then the thermal shrinkage tape is subjected to thermal shrinkage, so that the assembled batteries are fastened.

Here, in FIGS. 7 and 8, the single batteries 21 connected in series are illustrated. However, to increase a battery capacity, the single batteries 21 may be connected in parallel or may be connected in a combination form of series connection and parallel connection. The assembled battery packs can also be connected in series or in parallel.

According to the above-described embodiment, by providing the nonaqueous electrolyte batteries having the excellent charging and discharging cycle performance of the foregoing third embodiment, it is possible to provide the battery pack having the excellent charging and discharging cycle performance.

The form of the battery pack can be appropriately modified according to a use application. A use application of the battery pack according to the embodiment is preferably one which is required to show excellent cycle characteristics when a large current is extracted. Specifically, the battery pack can be used for power of digital cameras, a two-wheeled or four-wheeled hybrid electric vehicle, a two-wheeled or four-wheeled electric vehicle, an assist bicycle, and the like. In particular, the battery pack using the nonaqueous electrolyte batteries with excellent high temperature characteristics is appropriately used for vehicles.

While certain embodiments have been described above, these embodiments have been presented by way of example only, and are note intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### EXAMPLES

### Example 1

### [Production of First Active Material] <Synthesis of Active Material Substrate>

As the starting materials, potassium carbonate (K₂CO₃) and the anatase type titanium oxide (TiO₂) were used. The starting materials were mixed and burned at 1000° C. for 24 hours so as to synthesize the potassium titanate compound (K₂Ti₄O₉). This potassium titanate compound was subjected to the dry pulverization to adjust the particle size thereof, and then was washed with distilled water so as to obtain the proton exchange precursor.

The obtained proton exchange precursor was added in the hydrochloric acid solution having a concentration of 1 mol/L, and the ultrasonic stirring was carried out at 25° C. for 1 hour (the acid treatment). This acid treatment was repeated 12 times while renewing the hydrochloric acid solution. After the completion of the acid treatment, the product was washed with distilled water so as to obtain the proton titanate compound. Then, the proton titanate compound was burned in the atmosphere at 350° C. for 3 hours so as to obtain the titanium oxide with the TiO₂ structure which contained no hetero element, i.e. the active material substrate. The obtained titanium oxide with the TiO₂ structure was subjected to the additional heating treatment at 200° C. for 5 hours for the purpose of moisture removal.

### <Formation of Inorganic Compound Layer>

In the titanium oxide with the TiO₂ structure (15 g) synthesized as described above, tetraethoxysilane (7 g) and pure water (1 g) were added and mixed to obtain the mixture. Then, the powder in the mixture was subjected to the drying treatment in room temperature environment (25° C., relative humidity (RH): 50%), and it was confirmed that the mass of the dried powder was increased by 12 mass % relative to the mass of the titanium oxide. Moreover, the dried powder was subjected to the drying treatment in the atmosphere at 200° C. for 1 hour so as to obtain the first active material of Example 1.

The mass of the first active material was increased by 4 mass % ({(the first active material−the titanium oxide with the TiO₂ (B) structure)/the first active material}×100 (the adherence amount of the inorganic compound layer (%))).

Also, the surface of the first active material was observed by SEM-EDX. As a result, it was confirmed that the inorganic compound layer composed of the Si oxide was formed on the surface of the titanium oxide (TiO₂).

In the similar manner as above, the first active material was observed by TEM, and the outer periphery of the active material was subjected to the point analysis using EDX. Then, the peak of Si was significantly observed, and it was confirmed that the oxides containing Si as a main component was formed on the surface of the active material.

### <Second Active Material>

As the second active material, Li₄Ti₅O₁₂ was prepared.

### <Preparation of Carbon Coating Layer>

The second active material (100 g) was mixed with the aqueous solution (70 g) containing 2% sucrose, and the moisture was evaporated while stirring the solution at room temperature to 50° C. Then, the thermal treatment was carried out in an Ar atmosphere at 800° C. for 5 hours, to thereby form the carbon coating layer on the surface of the second active material.

The mass of the carbon coating layer with respect to the mass of the second active material ((the carbon coating layer/the second active material)×100 (carbon concentration)) was 1.3 mass %.

### <Preparation of Negative Electrode>

The aforementioned first active material and the second active material having the surface, on which the carbon coating layer was formed, were mixed at the mass ratio of 50:50, and the mixture was used as the battery active material of Example 1.

The battery active material of Example 1 (90 mass %), acetylene black (5 mass %), and polyvinylidene fluoride (PVdF) (5 mass %) were mixed with NMP so as to prepare the slurry. This slurry was applied to both surfaces of the current collector composed of aluminum foil having a thickness of 15 μm, and the coated current collector was dried and then pressed to thereby prepare the negative electrode having an electrode density of 2.0 g/cm³.

### <Preparation of Positive Electrode>

The lithium-nickel composite oxide (LiNi_{0.82}Co_{0.15}Al_{0.03}O₂) was used as the positive electrode active material. Also, acetylene black was used as the conductive agent, and polyvinylidene fluoride (PVdF) was used as the binder. The lithium-nickel composite oxide (90 mass %), acetylene black (5 mass %), and polyvinylidene fluoride (PVdF) (5 mass %) were mixed with NMP so as to prepare the slurry. This slurry was applied to both surfaces of the current collector composed of aluminum foil having a thickness of 15 μm, and the coated current collector was dried and then pressed to thereby prepare the positive electrode having an electrode density of 3.15 g/cm³.

### <Preparation of Electrode Group>

The positive electrode, the separator formed of the polyethylene porous film having a thickness of 25 μm, the negative electrode, and the separator were laminated in this order, and was wound spirally. This laminate was subjected to the hot press at 90° C., to thereby prepare the flattened electrode group having a width of 30 mm and a thickness of 3.0 mm. The obtained electrode group was stored in the pack formed of the laminate film, and was dried in a vacuum at 80° C. for 24 hours. The laminate film was configured by forming the polypropylene layer on both surfaces of the aluminum foil having a thickness of 40 μm, and the total thickness was 0.1 mm.

### <Preparation of Liquid Nonaqueous Electrolyte>

Ethylene carbonate (EC) and ethyl methyl carbonate (EMC) were mixed at the volume ratio of 1:2 so as to prepare the mixed solvent. In this mixed solvent, LiPF₆ (1 mol) was dissolved as the electrolyte so as to prepare the liquid nonaqueous electrolyte.

### <Production of Nonaqueous Electrolyte Secondary Battery>

The liquid nonaqueous electrolyte was injected into the pack of the laminate film in which the electrode group was stored. Then, the pack was completely sealed by heat sealing so as to produce the nonaqueous electrolyte secondary battery having a width of 35 mm, a thickness of 3.2 mm, and a height of 65 mm as shown in FIG. 3.

### Example 2

### Synthesis of Active Material Substrate

As the starting materials, potassium carbonate (K₂CO₃), the anatase type titanium oxide (TiO₂), and niobium hydroxide (Nb₂O₅.nH₂O) were used. The starting materials were mixed and subjected to the thermal treatment at 1000° C. for 5 hours, to thereby obtain the Nb-containing potassium titanate compound. This Nb-containing potassium titanate compound was pulverized using a ball mill and subjected to the acid treatment. Then, the treated compound was neutralized by adding the lithium hydroxide aqueous solution, and washed with distilled water so as to obtain the Nb-containing proton titanate compound. Then, the Nb-containing proton titanate compound was burned in the atmosphere at 350° C. for 4 hours, and further subjected to the thermal treatment at 200° C. for 3 hours so as to obtain the Nb-containing titanium oxide with the TiO₂ structure, i.e. the active material substrate.

The obtained Nb-containing titanium oxide with the TiO₂ structure was measured by ICP emission spectroscopy. As a result, the content of Nb was 8 mass % relative to the total mass of the Nb-containing titanium oxide with the TiO₂ (B) structure ((Nb/the Nb-containing titanium oxide with the TiO₂ (B) structure)×100).

The first active material of Example 2 was obtained in the same manner as Example 1 except for using the Nb-containing titanium oxide with the TiO₂ structure instead of the titanium oxide with the TiO₂ structure.

The mass of the first active material (having been subjected to the drying treatment in room temperature environment and subsequently the drying treatment at 200° C. for 1 hour) was increased by 4 mass % relative to the mass of the synthesized Nb-containing titanium oxide with the TiO₂ structure.

Also, the surface of the first active material was observed by SEM-EDX. As a result, it was confirmed that the inorganic compound layer composed of the Si oxide was formed on the surface of the Nb-containing titanium oxide (TiO₂).

### <Second Active Material>

As the second active material, Li₄Ti₅O₁₂ was prepared in the same manner as Example 1.

### <Preparation of Carbon Coating Layer>

The carbon coating layer was formed on the surface of the second active material in the same manner as Example 1 except for mixing the second active material (100 g) with the aqueous solution (140 g) containing 2% sucrose.

The mass of the carbon coating layer with respect to the mass of the second active material was 2.5 mass %.

### <Production of Nonaqueous Electrolyte Secondary Battery>

The nonaqueous electrolyte secondary battery was produced in the same manner as Example 1 except that the aforementioned first active material and the second active material having the surface, on which the carbon coating layer was formed, were mixed at the mass ratio of 50:50, and the negative electrode is formed by using the mixture as the battery active material of Example 2.

### Example 3

### Formation of Inorganic Compound Layer

The first active material of Example 3 was obtained in the same manner as Example 1 except that to the Nb-containing titanium oxide with the TiO₂ structure synthesized in Example 2 (15 g), tetraethoxysilane (15 g) and pure water (5 g) were added and mixed to prepare the mixture.

The mass of the first active material subjected to the drying treatment in room temperature environment (25° C., RH: 50%) was increased by 20 mass % relative to the mass of the synthesized Nb-containing titanium oxide with the TiO₂ structure.

Also, the mass of the first active material, which has been subjected to the drying treatment in room temperature environment and subsequently the drying treatment at 200° C. for 1 hour, was increased by 15 mass % relative to the mass of the synthesized Nb-containing titanium oxide with the TiO₂ structure.

Also, the surface of the first active material was observed by SEM-EDX. As a result, it was confirmed that the inorganic compound layer composed of the Si oxide was formed on the surface of the Nb-containing titanium oxide (TiO₂).

### <Second Active Material> <Preparation of Carbon Coating Layer>

As the second active material, Li₄Ti₅O₁₂ was prepared in the same manner as Example 1, and the carbon coating layer was formed on the surface of the second active material in the same manner as Example 1.

### <Production of Nonaqueous Electrolyte Secondary Battery>

The nonaqueous electrolyte secondary battery was produced in the same manner as Example 1 except that the aforementioned first active material and the second active material having the surface, on which the carbon coating layer was formed, were mixed at the mass ratio of 50:50, and the negative electrode is formed by using the mixture as the battery active material of Example 3.

### Example 4

### Formation of Inorganic Compound Layer

The first active material of Example 4 was obtained in the same manner as Example 1 except that to the Nb-containing titanium oxide with the TiO₂ structure synthesized in Example 2 (15 g), tetraethoxysilane (4 g) and pure water (2 g) were added and mixed to prepare the mixture.

The mass of the first active material subjected to the drying treatment in room temperature environment (25° C., RH: 50%) was increased by 10 mass % relative to the mass of the synthesized Nb-containing titanium oxide with the TiO₂ structure.

Also, the mass of the first active material, which has been subjected to the drying treatment in room temperature environment and subsequently the drying treatment at 200° C. for 1 hour, was increased by 5 mass % relative to the mass of the synthesized Nb-containing titanium oxide with the TiO₂ structure.

Also, the surface of the first active material was observed by SEM-EDX. As a result, it was confirmed that the inorganic compound layer composed of the Si oxide was formed on the surface of the Nb-containing titanium oxide (TiO₂).

### <Second Active Material>

As the second active material, Li₄Ti₅O₁₂ was prepared in the same manner as Example 1.

### <Preparation of Carbon Coating Layer>

The first active material (100 g) was mixed with the aqueous solution (50 g) containing 2.5% sucrose, and the moisture was evaporated while stirring the solution at room temperature to 50° C. Then, the thermal treatment was carried out in an Ar atmosphere at 350° C. for 4 hours, to thereby form the carbon coating layer on the surface of the first active material.

The mass of the carbon coating layer with respect to the mass of the first active material ((the carbon coating layer/the first active material)×100 (carbon concentration)) was 1.2 mass %.

### <Production of Nonaqueous Electrolyte Secondary Battery>

The nonaqueous electrolyte secondary battery was produced in the same manner as Example 1 except that the aforementioned first active material having the surface, on which the carbon coating layer was formed, and the second active material were mixed at the mass ratio of 50:50, and the negative electrode is formed by using the mixture as the battery active material of Example 4.

### Example 5

The nonaqueous electrolyte secondary battery was produced in the same manner as Example 2 except for using the first active material of Example 3.

### Example 6

The first active material of Example 6 was obtained in the same manner as Example 1 except that to the Nb-containing titanium oxide with the TiO₂ structure synthesized in Example 2 (15 g), tetraethoxysilane (4 g) and pure water (2 g) were added and mixed to prepare the mixture.

Also, the mass of the first active material (having been subjected to the drying treatment in room temperature environment and subsequently the drying treatment at 200° C. for 1 hour) was increased by 10 mass % relative to the mass of the synthesized Nb-containing titanium oxide with the TiO₂ structure.

Also, the surface of the first active material was observed by SEM-EDX. As a result, it was confirmed that the inorganic compound layer composed of the Si oxide was formed on the surface of the Nb-containing titanium oxide (TiO₂).

Then, the nonaqueous electrolyte secondary battery was produced in the same manner as Example 4 except for mixing the first active material (100 g) with the aqueous solution (35 g) containing 2.5% sucrose.

The mass of the carbon coating layer with respect to the mass of the first active material (carbon concentration) was 0.8 mass %.

### Example 7

The first active material of Example 7 was obtained in the same manner as Example 1 except that to the Nb-containing titanium oxide with the TiO₂ structure synthesized in Example 2 (15 g), tetraethoxysilane (13 g) and pure water (5 g) were added and mixed to prepare the mixture.

Also, the mass of the first active material (having been subjected to the drying treatment in room temperature environment and subsequently the drying treatment at 200° C. for 1 hour) was increased by 8 mass % relative to the mass of the synthesized Nb-containing titanium oxide with the TiO₂ structure.

Also, the surface of the first active material was observed by SEM-EDX. As a result, it was confirmed that the inorganic compound layer composed of the Si oxide was formed on the surface of the Nb-containing titanium oxide (TiO₂).

Then, the nonaqueous electrolyte secondary battery was produced in the same manner as Example 4 except for mixing the first active material (100 g) with the aqueous solution (45 g) containing 2.5% sucrose.

The mass of the carbon coating layer with respect to the mass of the first active material (carbon concentration) was 0.8 mass %.

### Example 8

Then, the battery active material of Example 8 was obtained in the same manner as Example 1, and the nonaqueous electrolyte secondary battery was produced in the same manner as Example 1, except for mixing the second active material (100 g) with the aqueous solution (45 g) containing 2% sucrose.

The mass of the carbon coating layer with respect to the mass of the second active material (carbon concentration) was 0.8 mass %.

### Example 9

### Formation of Inorganic Compound Layer

Firstly, to the aluminum nitrate aqueous solution having a concentration of 1 mol/L (30 mL), the sodium hydroxide aqueous solution having a concentration of 1 mol/L was added dropwise while stirring with a stiffer, so as to prepare the precipitate of aluminum hydroxide. Then, in the container in which the precipitate of aluminum hydroxide was produced, the Nb-containing titanium oxide with the TiO₂ (B) structure (15 g) synthesized in Example 2 was added to prepare the mixture. Then, the solution and the solid component were separated from each other. The solid component was washed, dried in the room temperature environment, and subsequently subjected to the drying treatment in the atmosphere at 250° C. for 2 hour so as to obtain the first active material of Example 9.

The surface of the first active material was observed by SEM-EDX. As a result, it was confirmed that the coating layer composed of aluminum oxide was formed on the surface of the Nb-containing titanium oxide (TiO₂).

The first active material was measured by ICP emission spectroscopy, and the result showed that the mass (adherence amount) of aluminum oxide was 10 mass % relative to the mass of the first active material.

Then, the nonaqueous electrolyte secondary battery was produced in the same manner as Example 1 by using the first active material of Example 9 as the first active material.

### Example 10

The first active material of Example 10, in which the coating layer composed of aluminum oxide was formed on the surface of the Nb-containing titanium oxide (TiO₂), was obtained in the same manner as Example 9 except for using the aluminum nitrate aqueous solution having a concentration of 1 mol/L (10 mL).

The surface of the first active material was observed by SEM-EDX. As a result, it was confirmed that the coating layer composed of aluminum oxide was formed on the surface of the Nb-containing titanium oxide (TiO₂).

The first active material was measured by ICP emission spectroscopy, and the result showed that the mass (adherence amount) of aluminum oxide was 3 mass % relative to the mass of the first active material.

Then, the carbon coating layer was formed on the surface of the aforementioned first active material of Example 10 in the same manner as Example 4, and the nonaqueous electrolyte secondary battery was produced in the same manner as Example 4.

### Example 11

The first active material of Example 11, in which the coating layer composed of aluminum oxide was formed on the surface of the Nb-containing titanium oxide (TiO₂), was obtained in the same manner as Example 9 except for using the aluminum nitrate aqueous solution having a concentration of 1 mol/L (12 mL).

The surface of the first active material was observed by SEM-EDX. As a result, it was confirmed that the coating layer composed of aluminum oxide was formed on the surface of the Nb-containing titanium oxide (TiO₂).

The first active material was measured by ICP emission spectroscopy, and the result showed that the mass (adherence amount) of aluminum oxide was 3 mass % relative to the mass of the first active material.

Then, the carbon coating layer was formed on the surface of the aforementioned first active material of Example 11 in the same manner as Example 6, and the nonaqueous electrolyte secondary battery was produced in the same manner as Example 6.

### Example 12

The nonaqueous electrolyte secondary battery was produced in the same manner as Example 2 except that the amount of acetylene black in the negative electrode was set to 0 mass % in Example 2.

### Example 13

The nonaqueous electrolyte secondary battery was produced in the same manner as Example 1 except that the concentration of the carbon coating layer of the second active material was set to 0.2 mass % in Example 1.

### Example 14

The nonaqueous electrolyte secondary battery was produced in the same manner as Example 6 except that the concentration of the carbon coating layer of the first active material was set to 0.1 mass % in Example 6.

### Comparative Example 1

The nonaqueous electrolyte secondary battery was produced in the same manner as Example 1 except that the carbon coating layer was not formed in the second active material in Example 1.

### Comparative Example 2

The nonaqueous electrolyte secondary battery was produced in the same manner as Example 4 except that the carbon coating layer was not formed in the first active material in Example 4.

### Comparative Example 3

The nonaqueous electrolyte secondary battery was produced in the same manner as Example 12 except that the carbon coating layer was not formed in the second active material in Example 12.

Table 1 shows the active material substrate, the inorganic compound, the raw material of the second active material, the adherence amount of the inorganic compound, the type of the active material coated with the carbon coating layer, and the carbon concentration of Examples 1 to 14 and Comparative Examples 1 to 3.

TABLE 1

| | | | | | Adherence | Active | |
|---|---|---|---|---|---|---|---|
| | | | | | amount of | material | |
| | | | | Second | inorganic | coated with | Carbon |
| | | Active material | Inorganic | active | compound | carbon coating | concentration |
| | | substrate | compound | material | (mass %) | layer | (mass %) |
| Examples | 1 | TiO₂ (B) | Si oxide | Li₄Ti₅O₁₂ | 4 | Second active | 1.3 |
| | | | | | | material | |
| | 2 | Nb-containing | Si oxide | Li₄Ti₅O₁₂ | 4 | Second active | 2.5 |
| | | TiO₂ (B) | | | | material | |
| | 3 | Nb-containing | Si oxide | Li₄Ti₅O₁₂ | 15 | Second active | 1.3 |
| | | TiO₂ (B) | | | | material | |
| | 4 | Nb-containing | Si oxide | Li₄Ti₅O₁₂ | 5 | First active | 1.2 |
| | | TiO₂ (B) | | | | material | |
| | 5 | Nb-containing | Si oxide | Li₄Ti₅O₁₂ | 15 | Second active | 2.5 |
| | | TiO₂ (B) | | | | material | |
| | 6 | Nb-containing | Si oxide | Li₄Ti₅O₁₂ | 10 | First active | 0.8 |
| | | TiO₂ (B) | | | | material | |
| | 7 | Nb-containing | Si oxide | Li₄Ti₅O₁₂ | 8 | First active | 0.8 |
| | | TiO₂ (B) | | | | material | |
| | 8 | TiO₂ (B) | Si oxide | Li₄Ti₅O₁₂ | 4 | Second active | 0.8 |
| | | | | | | material | |
| | 9 | Nb-containing | Al oxide | Li₄Ti₅O₁₂ | 10 | Second active | 1.3 |
| | | TiO₂ (B) | | | | material | |
| | 10 | Nb-containing | Al oxide | Li₄Ti₅O₁₂ | 3 | First active | 1.2 |
| | | TiO₂ (B) | | | | material | |
| | 11 | Nb-containing | Al oxide | Li₄Ti₅O₁₂ | 3 | First active | 0.8 |
| | | TiO₂ (B) | | | | material | |
| | 12 | Nb-containing | Si oxide | Li₄Ti₅O₁₂ | 4 | Second active | 2.5 |
| | | TiO₂ (B) | | | | material | |
| | 13 | TiO₂ (B) | Si oxide | Li₄Ti₅O₁₂ | 4 | Second active | 0.2 |
| | | | | | | material | |
| | 14 | Nb-containing | Si oxide | Li₄Ti₅O₁₂ | 10 | First active | 0.1 |
| | | TiO₂ (B) | | | | material | |
| Comparative | 1 | TiO₂ (B) | Si oxide | Li₄Ti₅O₁₂ | 4 | Absent | — |
| examples | 2 | Nb-containing | Si oxide | Li₄Ti₅O₁₂ | 5 | Absent | — |
| | | TiO₂ (B) | | | | | |
| | 3 | Nb-containing | Si oxide | Li₄Ti₅O₁₂ | 4 | Absent | — |
| | | TiO₂ (B) | | | | | |

### (Charging and Discharging Cycle Test)

The charging and discharging cycle test was carried out for the monopolar cells of the negative electrode which were obtained by using metal lithium as the counter electrode and the reference electrode in the non-aqueous electrolyte secondary batteries of Examples 1 to 14 and Comparative Examples 1 to 3. Through this test, the capacity retention ratio and the resistance increasing ratio were measured.

The charging and discharging were carried out at 1 C rate in the environment of 45° C. As the charging, the constant current-constant voltage charging of 1.4 V was carried out, and the charging time was set to 3 hours. The constant current discharging was carried out while the discharging cut-off voltage was set to 3.0 V. The charging and discharging were carried out 50 cycles (one cycle is defined as charging/discharging), and the initial capacity, the capacity after 50 cycles, the resistance of the nonaqueous electrolyte battery before the initial charging and discharging, and the resistance of the nonaqueous electrolyte battery after 50 cycles were measured.

The initial capacity of Example 1 was defined as 100, and the initial capacities of the respective Examples and Comparative Examples were represented by the ratio (%). Also, in each of the Examples and Comparative Examples, the capacity retention ratio (%) after 50 cycles was calculated from the capacity after 50 cycles to the initial capacity. Also, the resistance (R₀) of the battery before the initial charging and discharging was defined as 1.0, and the resistance increasing ratio R₅₀/R₀ (%) after 50 cycles was calculated from the battery resistance (R₅₀) after 50 cycles.

Table 2 shows the initial capacity ratio (%), the capacity retention ratio (%) and the resistance increasing ratio R₅₀/R₀ (%) in each of the batteries.

TABLE 2

| | | | Capacity | Resistance |
|---|---|---|---|---|
| | | Initial capacity | retention ratio | increasing |
| | | ratio (%) | (%) | ratio (%) |
| Examples | 1 | 100 | 84 | 116 |
| | 2 | 95 | 85 | 117 |
| | 3 | 90 | 93 | 102 |
| | 4 | 105 | 82 | 118 |
| | 5 | 90 | 90 | 106 |
| | 6 | 108 | 81 | 118 |
| | 7 | 96 | 90 | 105 |
| | 8 | 103 | 85 | 115 |
| | 9 | 100 | 83 | 117 |
| | 10 | 105 | 82 | 118 |
| | 11 | 110 | 81 | 120 |
| | 12 | 85 | 80 | 125 |
| | 13 | 102 | 72 | 230 |
| | 14 | 113 | 65 | 250 |
| Comparative | 1 | 103 | 50 | 280 |
| examples | 2 | 108 | 55 | 270 |
| | 3 | 90 | 40 | 300 |

As shown in Table 1 and Table 2, it was revealed that the formation of the carbon coating layer on the surface of any one of the first and second active materials could improve the capacity retention ratio and the resistance increasing ratio, and could suppress the deterioration in a capacity and the increase in resistance when using the battery active material including the first active material, i.e. an acid active material, and the second active material, i.e. a basic active material. Particularly, it was revealed from the results of Example 12 and Comparative

Example 3 that the effects of suppressing the deterioration in a capacity and the increase in resistance, which resulted from the formation of the carbon coating layer on the surface of any one of the first and second active materials, were significant particularly when the carbon (acetylene black) was not contained as a conductive agent in the negative electrode.

1. A battery active material comprising:
a first active material containing a neutral or acidic active material substrate formed of a titanium oxide or a titanate compound, and an inorganic compound layer covering a surface of the active material substrate; and
a basic second active material formed of a titanium oxide or a titanate compound, wherein
surfaces of the first active material and/or the second active material are covered with a carbon coating layer.

2. The battery active material according to claim 1, wherein, in the first active material, the active material substrate is formed of the titanium oxide, and the inorganic compound layer contains a metal oxide containing Al or Si.

3. The battery active material according to claim 1, wherein a thickness of the carbon coating layer is within a range of 10 to 1000 nm.

4. The battery active material according to claim 2, wherein the active material substrate having a crystal structure of a monoclinic titanium dioxide.

5. A nonaqueous electrolyte battery comprising:
a negative electrode containing the battery active material according to claim 1;
a positive electrode; and
a nonaqueous electrolyte.

6. A battery pack comprising the nonaqueous electrolyte battery according to claim 5.
